(19) United States
(12) Patent Application Publication
(10) Pub. No.: US 2026/0348665 A1
(43) Pub. Date: Nov. 5, 2026

(54) TEMPERATURE REGULATING BEDDING

(71) Applicant: Eight Sleep Inc., New York, NY (US)

(72) Inventors: Daniel David SACHS, San Francisco, CA (US); Matteo FRANCESCHETTI, Miami Shores, FL (US); Jaewon Samuel KANG, Oakland, CA (US); Alexander Igorevich LEDNEV, Forest Park, IL (US); Andrew KIM, San Francisco, CA (US); David HEINZ, San Francisco, CA (US)

(21) Appl. No.: 19/663,011

(22) Filed: Apr. 29, 2026

Related U.S. Application Data
(60) Provisional application No. 63/797,568, filed on Apr. 30, 2025.

(51) Int. Cl. F28D 1/00; G01D 5/14; G01K 13/02

(52) U.S. Cl. CPC F28D 1/00; G01D 5/145; G01K 13/02

(57) ABSTRACT

Disclosed herein are system, method, and device embodiments for providing bedding with enhanced temperature control, reduced weight for a user, and improved comfort. A temperature regulator may connect to fluid channels and a manifold within a blanket. The blanket may include different regulated temperature in a first thermal zone and a second thermal zone. The temperature regulator may also connect to fluid channels within a bed cover.

### CROSS-REFERENCE TO RELATED APPLICATIONS

This application claims the benefit of U.S. Provisional Patent Application No. 63/797,568 by Sachs, et al., “Systems and Methods for Regulating Temperature of a Bedding,” filed Apr. 30, 2025, which is incorporated by reference herein in its entirety.

### BACKGROUND

Regulating a temperature of an article of furniture can help improve a quality of a person’s activity on the furniture. For example, fluid (e.g., liquid or gas) can be directed to flow within the article of furniture. Temperature of the fluid can be modulated to effect regulation of temperature of the article of furniture, to effect improvement of the person’s quality of sleep.

### BRIEF SUMMARY

Disclosed herein is a system for regulating bedding temperature. The system can include a blanket and a plurality of fluid channels disposed within the blanket. The temperature regulator fluidically coupled to the plurality of fluid channels may be configured to circulate a fluid through the plurality of fluid channels to regulate a temperature of the blanket.

In an aspect, the blanket can include a first thermal zone disposed in a first area of the blanket and a second thermal zone disposed in a second area of the blanket. In an aspect, the system can include a manifold disposed within the blanket, the manifold configured to divide a flow of the fluid into the plurality of fluid channels. The manifold may be a first manifold configured to divide a first flow of the fluid into a first plurality of fluid channels in the first thermal zone. A second manifold disposed within the blanket may divide a second flow of the fluid into a second plurality of fluid channels in the second thermal zone.

In an aspect, the system can include a memory and at least one processor coupled to the memory and configured to obtain a current temperature and a target temperature of at least a portion of the blanket and direct the temperature regulator to change the current temperature based on the target temperature. In an aspect, a first portion of the blanket has a lower density of the plurality of fluid channels compared to a second portion of the blanket.

In an aspect, the system includes at least one elongate support member disposed between two fluid channels of the plurality of fluid channels. In an aspect, a cross-sectional dimension of the elongate support member and a cross-sectional dimension of a fluid channel adjacent to the elongate support member are substantially the same. In an aspect, a first portion of the blanket provides a first temperature to a first body part of a user and a second portion of the blanket provides a second temperature to a second body part of a user.

In an aspect, the blanket comprises a first fabric layer disposed above the plurality of fluid channels and a second fabric layer disposed below the plurality of fluid channels, wherein at least a portion of the first fabric layer and at least a portion of the second fabric layer are coupled to one another to enclose the plurality of fluid channels between the first fabric layer and the second fabric layer.

In an aspect, the plurality of fluid channels comprises at least one horizontally-oriented fluid channel disposed at a top region of the blanket. In an aspect, at least one fluid channel of the plurality of fluid channels comprises an internal X-spline configured to provide kink resistance.

In an aspect, the system further includes a bed cover and a second plurality of fluid channels disposed within the bed cover. The temperature regulator may be fluidically coupled to the second plurality of fluid channels and may be configured to circulate the fluid through the second plurality of fluid channels to regulate a temperature of the bed cover. In an aspect, the blanket and the bed cover are regulated to a same temperature. In another aspect, the blanket and the bed cover are regulated to different temperatures. In an aspect, the system can include a memory and at least one processor coupled to the memory and configured to synchronize a current temperature of the bed cover and the blanket. In an aspect, the system comprises a first umbilical fluidically connecting the temperature regulator to the bed cover and a second umbilical fluidically connecting the temperature regulator to the blanket.

In an aspect, the system further includes a first umbilical fluidically connecting the temperature regulator to the bed cover and a second umbilical fluidically connecting the bed cover to the blanket. In an aspect, the system further includes a magnetic field sensor that detects a left or right orientation of the blanket based on a polarity of a magnet. In an aspect, the system further includes a temperature drop sensor on a fluid exit channel from the blanket used to determine a temperature drop within the blanket. In an aspect, the blanket comprises a bottom side and a top side opposite the bottom side, wherein the bottom side and the top side exhibit different heat transfer coefficient values.

Some embodiments relate to a method for regulating bedding temperature. The method can include receiving data indicating a current temperature of a blanket, determining a target temperature for the blanket that differs from the current temperature, and directing a temperature regulator fluidically coupled to the blanket to change the current temperature of the blanket to the target temperature by circulating a fluid through a plurality of fluid channels, the plurality of fluid channels at least partially disposed within the blanket.

Some embodiments relate to a non-transitory computer-readable device having instructions stored thereon. When the instructions are executed by at least one computing device, the instructions cause the at least one computing device to perform operations for regulating bedding including receiving data indicating a current temperature of a blanket, determining a target temperature for the blanket that differs from the current temperature, and directing a temperature regulator fluidically coupled to the blanket to change the current temperature of the blanket to the target temperature by circulating a fluid through a plurality of fluid channels, the plurality of fluid channels at least partially disposed within the blanket.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIGS. 1A-1C shows an exemplary configuration of a bedding described herein. FIG. 1A shows a top view of a mattress with the mattress cover and blanket. The connections from the reservoir (e.g., hub) are shown from the top view and foot view of the mattress. FIG. 1B shows a bottom view of the mattress with the mattress cover. FIG. 1C shows a foot view of the mattress.

FIGS. 2A-2C show an exemplary configuration of a bedding described herein. FIG. 2A shows a top view of a mattress with the mattress cover and blanket. The connections from the reservoir (e.g., hub) are shown from the top view and foot view of the mattress. FIG. 2B shows a bottom view of the mattress with the mattress cover. FIG. 2C shows a foot view of the mattress.

FIG. 3 shows a representation of a bedding described herein. The bedding has two umbilical cords to provide connections from a reservoir (e.g., hub) to the bedding (e.g., blanket).

FIG. 4 shows an exemplary layer structure of the bedding. The layers can be, from top to bottom, a top layer, a top face lining, a top filling, a top quilt lining, a middle face, a tube (e.g., tube manifold), a middle back, and a bottom face. The layer structure can increase comfort, insulation, and quality of thermoregulation.

FIG. 5 shows an arrangement of tubes in the bedding. The tube arrangement can provide improved water flow to the bedding and reduce blockages in the tubes. The arrangement in FIG. 5 has eight zones of the blanket and eight channels.

FIG. 6 shows a representation of a tube manifold. The manifold can be a flexible manifold or a distributed manifold.

FIG. 7 shows a representation of elongate support members (e.g., ropes) for the bedding described herein. The elongate support members can be laid in between the tube arrangement.

FIG. 8 shows a computer system that is programmed or otherwise configured to implement methods provided herein.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Recognized herein is a need for improved thermo-regulation of an article of furniture (e.g., a blanket, sheet, cover, or combination thereof). The systems and methods described herein can provide for an article of furniture (e.g., a blanket) with enhanced temperature control, reduced weight for a user, and improved comfort. The systems and methods provided herein can provide for a better night sleep for a user.

In an aspect, the present disclosure provides a system for regulating a temperature of a bedding, the system comprising: (i) a blanket configured to be placed over at least one body part of a user to provide temperature regulation to the at least one body part of the user; and (ii) a plurality of fluid channels housed within the blanket and coupled to a manifold, wherein the manifold is configured to split a flow of a temperature-regulated fluid into the plurality of fluid channels, wherein the temperature-regulated fluid is operatively coupled to a temperature regulator for temperature regulation.

In some embodiments, the plurality of fluid channels comprises a first fluid channel and a second fluid channel that are disposed in at least two zones of the blanket, wherein the at least two zones are different and substantially non-overlapping with one another.

In some embodiments, the first fluid channel and the second fluid channel are oriented in different directions relative to one another. In some embodiments, a density of the plurality of fluid channels along an area of the blanket is non-uniform. In some embodiments, a portion of the blanket corresponding to a lower body of the user has a lower density of the plurality of fluid channels as compared to an additional portion of the blanket corresponding to an upper body of the user.

In some embodiments, the system further comprises an elongate support member disposed between two fluid channels of the plurality of fluid channels, wherein the elongate support member is not configured to direct flow of a temperature-regulated fluid, and wherein a cross-sectional dimension of the elongate support member and a cross-sectional dimension of a fluid channel adjacent to elongate support member are substantially the same or different by at most about 30%, at most about 20%, at most about 10%, or at most about 5%.

In some embodiments, the cross-sectional dimension of the elongate support member is smaller than the cross-sectional dimension of the fluid channel. In some embodiments, the elongate support member comprises a textile material.

In some embodiments, the system further comprises a first fabric layer disposed above the plurality of fluid channels and a second fabric layer disposed below the plurality of fluid channels. In some embodiments, at least a portion of the first fabric layer and at least a portion of the second fabric layer are stitched to one another, to at least partially hold the plurality of fluid channels. In some embodiments, at least a portion of the first fabric layer and at least a portion of the second fabric layer are secured to one another using securing means (e.g., stitching, Velcro, buttons, glue, etc.).

In some embodiments, the blanket has a bottom side configured to be in contact with the at least one body part of the user and a top side opposite the bottom side, wherein the bottom side and the top side exhibit different heat transfer coefficient values. In some embodiments, the manifold is housed within the blanket.

In some embodiments, the system further comprises a fluid port in fluid communication with the manifold, wherein the fluid port is configured to reversibly couple to an inlet fluid channel configured to direct flow of the temperature-regulated fluid through the fluid port and towards the manifold. In some embodiments, one or more of the fluid port or the inlet fluid channel comprise a magnet to provide the reversible coupling.

In some embodiments, the system further comprises a magnetic field sensor disposed adjacent to the fluid port, the inlet fluid channel, or both, where the magnetic field sensor is configured to detect the reversible coupling. In some embodiments, the plurality of fluid channels is disposed on a side of the blanket, wherein the system further comprises an additional fluid port in fluid communication with one or more fluid channels disposed on a different side of the blanket, wherein the fluid port and the additional fluid port exhibit opposite magnetic polarities.

In some embodiments, the system further comprises a bed cover configured to be placed under the at least one body part of the user to provide an additional temperature regulation to the at least one body part of the user. In some embodiments, the blanket and the bed cover are regulated to a same temperature. In some embodiments, the blanket and the bed cover are regulated to different temperatures. In some embodiments, temperature regulation is provided to a plurality of body parts of the user. In some embodiments, a first portion of the blanket is configured to provide a first temperature to a first body part of the user and a second portion of the blanket is configured to provide a second temperature to a second body part of the user. In some embodiments, the first body part of the user and the second body part of the user are different.

In some embodiments, the system further comprises a first manifold configured to split a flow of a first temperature-regulated fluid into a first plurality of fluid channels and a second manifold configured to split a flow of a second temperature-regulated fluid into a second plurality of fluid channels. In some embodiments, the first plurality of fluid channels provides the first temperature-regulated fluid to the first portion of the blanket and the second plurality of fluid channels provides the second temperature-regulated fluid to the second portion of the blanket.

In some embodiments, the system further comprises a sensor. In some embodiments, the sensor is a capacitance sensor, a temperature sensor, a pressure sensor, a piezo sensor, or any combination thereof. In some embodiments, the plurality of fluid channels comprises a thermoplastic, a thermoplastic elastomer (TPE), silicone, or polyvinyl chloride (PVC). In some embodiments, the TPE comprises a polyamide thermoplastic elastomer (TPA), a polystyrene thermoplastic elastomer (TPS), a polyurethane thermoplastic elastomer (TPU), an olefinic thermoplastic elastomer (TPO), a polyester thermoplastic elastomer (TPEE), a crosslinked thermoplastic rubber (TPV), or any combination thereof.

In some embodiments, the system further comprises a fluid flow controller. In some embodiments, the fluid flow controller is a pump or a valve.

In some embodiments, the blanket comprises a weight, wherein the weight of the blanket is at most about 20 pounds (lbs). In some embodiments, the weight of the blanket is at most 15 lbs. In some embodiments, the weight of the blanket is at most 10 lbs.

In some embodiments, the fluid is a liquid. In some embodiments, the fluid is a gas. In some embodiments, the system further comprises at least one reservoir.

In some aspects, the present disclosure provides a method for optimizing sleep of the user with the system described herein, the method including: (a) contacting the at least one body part of the user with the blanket; and (b) directing flow of the temperature-regulated fluid through the manifold and into the plurality of fluid channels housed within the blanket, optionally wherein regulation of the temperature of the temperature-regulated fluid is performed outside of the blanket.

While various embodiments of the invention have been shown and described herein, it will be obvious to those skilled in the art that such embodiments are provided by way of example only. Numerous variations, changes, and substitutions can occur to those skilled in the art without departing from the invention. It should be understood that various alternatives to the embodiments of the invention described herein can be employed.

### Definitions

Unless defined otherwise, all technical and scientific terms used herein have the same meaning as commonly understood by one of ordinary skill in the art to which the disclosure pertains.

The term “a” and “an” as used herein refer to one or to more than one (i.e., to at least one) of the grammatical object of the article, e.g., “an element” means one element or more than one element.

The term “about” or “approximately” as used herein refers to a measurable value such as an amount, a temporal duration, and the like, refers to being within a statistically meaningful range of variations of ±20% or in some instances ±10%, or in some instances ±5%, or in some instances ±1%, or in some instances ±0.1% from the specified value.

The terms “furniture,” “article of furniture,” or “piece of furniture,” as used interchangeably herein, generally refer to a bed, a pillow, crib, bassinet, chair, seat, loveseat, sofa, couch, head rest, stool, ottoman, bench, or any panel intended to be covered with a fabric. The article of furniture can be intended for use in a home, an office, a medical facility (e.g., a hospital) or on a vehicle of transportation such as a car, truck, boat, bus, train or the like. The article of furniture can be intended for use for at least one person (and/or at least one animal, such as a pet). The article of furniture can be intended for use for at least about 1, 2, 3, 4, 5, 6, 7, 8, 9, 10, or more persons. The article of furniture can be intended for use for at most about 10, 9, 8, 7, 6, 5, 4, 3, 2, or 1 person. In an example, the article of furniture may be a bed, and the bed may comprise a plurality of sizes comprising single, single extra-long, double, queen, king, super king, etc. In another example, the article of furniture may be an infant warmer (i.e., a babytherm) to provide heat at one or more temperatures to an infant.

The terms “bed” or “bed device,” as used interchangeably herein, may be an article of furniture used for sleep or rest. The bed may comprise a mattress, a mattress pad, a pillow, and/or a covering thereof (e.g., a blanket). One or more users may sleep or rest on and/or adjacent to a surface of the bed device. The surface may be a top surface of the bed device. The top surface of the bed device may be flat or textured. The bed device may be a mattress. The bed device may be a mattress pad that covers at least a portion of a surface of a mattress or at least a surface of the mattress. The bed device may be a pillow. Alternatively or in addition to, the user(s) may sleep under a surface of the bed device. The surface may be one or more surfaces of a covering, such as, for example, a blanket. The blanket may be disposed on top of at least a part of the user(s). The bed device may be the blanket.

A temperature of the article of furniture (e.g., the bed device, such as the mattress, the mattress pad, pillow, or the blanket) may be controlled (e.g., increasing, decreasing, or maintaining the temperature of the bed). A temperature of at least a portion of the article of furniture may be controlled. The temperature of the article of furniture may be adjustable or maintained prior to, during, or subsequent to a use (e.g., sleeping or resting for a period of time) by the user(s). In an example, the bed may be pre-warmed (e.g., automatically or per user preference) prior to the use by the user(s). In some cases, temperatures or two or more portions of the article of furniture (e.g., the bed) may be controlled separately or in sync.

A regulating unit (e.g., a temperature regulating unit) can be coupled (e.g., directly or indirectly) to at least a portion of the article of furniture, to control the temperature of the at least the portion of the article of furniture. In some embodiments, the regulating unit can comprise coils that can be heated and/or cooled. In some embodiments, a variety of heating or cooling mechanisms other than the coils can also be utilized. For example, forced directional gas (e.g., air) heating and/or cooling, liquid (e.g., water) heating and/or cooling, thermoelectric heating and/or cooling, modifications thereof, or combinations thereof can be used for controlling the temperature of the article of furniture, such as the bed device (e.g., mattress, pillow, or covering thereof).

The article of furniture (e.g., the bed) may use one or more sensors and/or one or more computer systems to detect sensing data (e.g., one or more biological signals) associated with the user. For example, the sensing data can be utilized to estimate or determine a condition of state of the user prior to, during, or subsequent to using the article of furniture (e.g., determine sleep phase, sleep pattern, disease, disorder, snoring, etc. of the user). The sensor(s) may or may not be a part of the article of furniture. The sensor(s) may be part of the article of furniture. The sensor(s) may be a part of a space (e.g., room) surrounding the article of furniture. The sensor(s) may be worn by the user(s). Non-limiting examples of a sensor can include a capacitance sensor, a temperature sensor, a pressure sensor, a piezoelectric sensor, sound sensor (e.g., a microphone), accelerometer, liquid pressure sensor, etc. The sensing data can be utilized (e.g., analyzed), at least in part, to determine how to regulate temperature of the article of furniture prior to, during, and subsequent to the user’s use of the article of furniture. In some cases, the sensor(s) may be used to detect a property (e.g., temperature, movement, etc.) of the article of furniture or such property of an environment surrounding the article of furniture. The sensor(s) of the article of furniture (e.g., coupled to, integrated into, embedded into, etc.) as provided herein can detect the sensing data when in contact (e.g., direct or indirect contact) with the subject or when not in contact with the subject.

### Systems for Regulating Temperature

In an aspect, provided herein is a system for regulating a temperature. The system can regulate temperature of a bedding. In some embodiments, the system may comprise a blanket. The blanket may be configured to be placed over at least one body part of a user. The blanket may be configured to provide temperature regulation to a user (e.g., at least one body part of a user). In some embodiments, the system comprises a plurality of fluid channels. The plurality of fluid channels may be housed within the blanket. The plurality of fluid channels may be coupled to a manifold. In some embodiments, the manifold may be configured to split a flow of a fluid (e.g., a temperature-regulated fluid). The manifold may be configured to split a flow of a fluid (e.g., a temperature-regulated fluid) into the plurality of fluid channels. In some embodiments, the temperature-regulated fluid may be operatively coupled to a temperature regulator. The temperature regulator may thus regulate a temperature of the fluid.

As an example, provided herein are systems for regulating a temperature of a bedding, the system comprising: (i) a blanket configured to be placed over at least one body part of a user to provide temperature regulation to the at least one body part of the user; and a plurality of fluid channels housed within the blanket and coupled to a manifold, wherein the manifold is configured to split a flow of a temperature-regulated fluid into the plurality of fluid channels, wherein the temperature-regulated fluid is operatively coupled to a temperature regulator for temperature regulation.

In some embodiments, the plurality of fluid channels may comprise one or more fluid channels (e.g., 1, 2, 3, 4, 5, 6, 7, 8, 9, 10, or more fluid channels). The plurality of fluid channels may comprise at least 1 fluid channel, at least 2 fluid channels, at least 3 fluid channels, at least 4 fluid channels, at least 5 fluid channels, at least 6 fluid channels, at least 7 fluid channels, at least 8 fluid channels, at least 9 fluid channels, at least 10 fluid channels, at least 15 fluid channels, or greater than about 15 fluid channels. The plurality of fluid channels may comprise at most about 15 fluid channels, at most about 10 fluid channels, at most about 9 fluid channels, at most about 8 fluid channels, at most about 7 fluid channels, at most about 6 fluid channels, at most about 5 fluid channels, at most about 4 fluid channels, at most about 3 fluid channels, at most about 2 fluid channels, or less than about 2 fluid channels.

In some embodiments, the plurality of fluid channels may comprise from about 1 fluid channel to about 20 fluid channels. In some embodiments, the plurality of fluid channels may comprise from about 1 fluid channel to about 2 fluid channels, about 1 fluid channel to about 3 fluid channels, about 1 fluid channel to about 4 fluid channels, about 1 fluid channel to about 5 fluid channels, about 1 fluid channel to about 6 fluid channels, about 1 fluid channel to about 7 fluid channels, about 1 fluid channel to about 8 fluid channels, about 1 fluid channel to about 9 fluid channels, about 1 fluid channel to about 10 fluid channels, about 1 fluid channel to about 15 fluid channels, about 1 fluid channel to about 20 fluid channels, about 2 fluid channels to about 3 fluid channels, about 2 fluid channels to about 4 fluid channels, about 2 fluid channels to about 5 fluid channels, about 2 fluid channels to about 6 fluid channels, about 2 fluid channels to about 7 fluid channels, about 2 fluid channels to about 8 fluid channels, about 2 fluid channels to about 9 fluid channels, about 2 fluid channels to about 10 fluid channels, about 2 fluid channels to about 15 fluid channels, about 2 fluid channels to about 20 fluid channels, about 3 fluid channels to about 4 fluid channels, about 3 fluid channels to about 5 fluid channels, about 3 fluid channels to about 6 fluid channels, about 3 fluid channels to about 7 fluid channels, about 3 fluid channels to about 8 fluid channels, about 3 fluid channels to about 9 fluid channels, about 3 fluid channels to about 10 fluid channels, about 3 fluid channels to about 15 fluid channels, about 3 fluid channels to about 20 fluid channels, about 4 fluid channels to about 5 fluid channels, about 4 fluid channels to about 6 fluid channels, about 4 fluid channels to about 7 fluid channels, about 4 fluid channels to about 8 fluid channels, about 4 fluid channels to about 9 fluid channels, about 4 fluid channels to about 10 fluid channels, about 4 fluid channels to about 15 fluid channels, about 4 fluid channels to about 20 fluid channels, about 5 fluid channels to about 6 fluid channels, about 5 fluid channels to about 7 fluid channels, about 5 fluid channels to about 8 fluid channels, about 5 fluid channels to about 9 fluid channels, about 5 fluid channels to about 10 fluid channels, about 5 fluid channels to about 15 fluid channels, about 5 fluid channels to about 20 fluid channels, about 6 fluid channels to about 7 fluid channels, about 6 fluid channels to about 8 fluid channels, about 6 fluid channels to about 9 fluid channels, about 6 fluid channels to about 10 fluid channels, about 6 fluid channels to about 15 fluid channels, about 6 fluid channels to about 20 fluid channels, about 7 fluid channels to about 8 fluid channels, about 7 fluid channels to about 9 fluid channels, about 7 fluid channels to about 10 fluid channels, about 7 fluid channels to about 15 fluid channels, about 7 fluid channels to about 20 fluid channels, about 8 fluid channels to about 9 fluid channels, about 8 fluid channels to about 10 fluid channels, about 8 fluid channels to about 15 fluid channels, about 8 fluid channels to about 20 fluid channels, about 9 fluid channels to about 10 fluid channels, about 9 fluid channels to about 15 fluid channels, about 9 fluid channels to about 20 fluid channels, about 10 fluid channels to about 15 fluid channels, about 10 fluid channels to about 20 fluid channels, or about 15 fluid channels to about 20 fluid channels.

A system may comprise a first fluid channel and a second fluid channel. The first fluid channel and the second fluid channel may be disposed in one or more zones of the blanket. The first fluid channel and the second fluid channel may be disposed in a same zone of the blanket. The first fluid channel and the second fluid channel may be disposed in different zones of the blanket. In some embodiments, the first fluid channel and the second fluid channel may be disposed in at least two zones of the blanket. Zones of the blanket may be different from one another. Zones of the blanket may overlap with one another. Zones of the blanket may not overlap with one another. Zones of the blanket may be substantially non-overlapping with one another. A zone of the blanket may be in a location that pertains to at least one body part of a user (e.g., a location that provides thermoregulation to the at least one body part of a user). In some embodiments, one or more zones of the blanket may provide thermoregulation to a same body part of a user. For example, a first zone of the blanket may provide thermoregulation to a torso (e.g., a region of a torso) of a user and second zone of the blanket may provide thermoregulation to a torso (e.g., a region of a torso) of the user. In some embodiments, one or more zones of the blanket may provide thermoregulation to different body parts of a user. For example, a first zone of the blanket may provide thermoregulation to a torso of a user and second zone of the blanket may provide thermoregulation to a leg of the user.

A fluid channel of the plurality of fluid channels may comprise a fluid flow path. A system can comprise at least about 1, 2, 3, 4, 5, 6, 7, 8, 9, 10 or more fluid flow paths for a fluid (e.g., a volume of fluid). Without wishing to be bound by theory, the multiple zones and/or plurality of fluid channels of a bedding (e.g., blanket) described herein may be advantageous to prevent and/or minimize kinks. For example, if the bedding (e.g., blanket) comprises four fluid channels in a zone and one fluid channel kinks, then three fluid channels may be able to retain fluid and provide thermoregulation to at least one body part of a user.

In some embodiments, two or more channels of the plurality of channels (e.g., a first fluid channel and a second fluid channel) may be oriented in a direction. In some embodiments, two or more channels of the plurality of channels (e.g., a first fluid channel and a second fluid channel) may be oriented in different directions relative to one another. In some embodiments, two or more channels of the plurality of channels (e.g., a first fluid channel and a second fluid channel) may be oriented in the same direction relative to one another. The channels may comprise tubes and/or tubing through which a volume of fluid may flow. The zones of the bedding (e.g., blanket) may comprise one or more fluid channels in a same orientation. For example, the fluid channels of the bedding may be vertical. As another example, the fluid channels of the bedding may be horizontal. The zones of the bedding (e.g., blanket) may comprise one or more fluid channels in different orientations. For example, a first zone of the bedding (e.g., blanket) may comprise one or more fluid channels that are in horizontal orientation and a second zone of the bedding (e.g., blanket) may comprise one or more fluid channels that are in vertical orientation. As another example, a zone of the bedding (e.g., blanket) may comprise one or more fluid channels in different orientations. A first zone of the bedding (e.g., blanket) may comprise one or more fluid channels that are in horizontal orientation and one or more fluid channels that are in vertical orientation. Without wishing to be bound by theory, the orientation of channels may improve a comfort of the bedding and/or a thermal performance of the bedding (e.g., blanket). The bedding (e.g., blanket) may comprise any number of horizontally-oriented fluid channels and/or any number of vertically-oriented fluid channels. For example, the plurality of fluid channels may comprise one or more horizontally-oriented fluid channels disposed at a top region of the bedding. In some embodiments, the bedding (e.g., blanket) may comprise symmetrical orientations of fluid channels. For example, a first side of the bedding may comprise a symmetrical orientation of fluid channels as that of a second side of the bedding. In some embodiments, the bedding (e.g., blanket) may comprise an asymmetrical orientation of fluid channels.

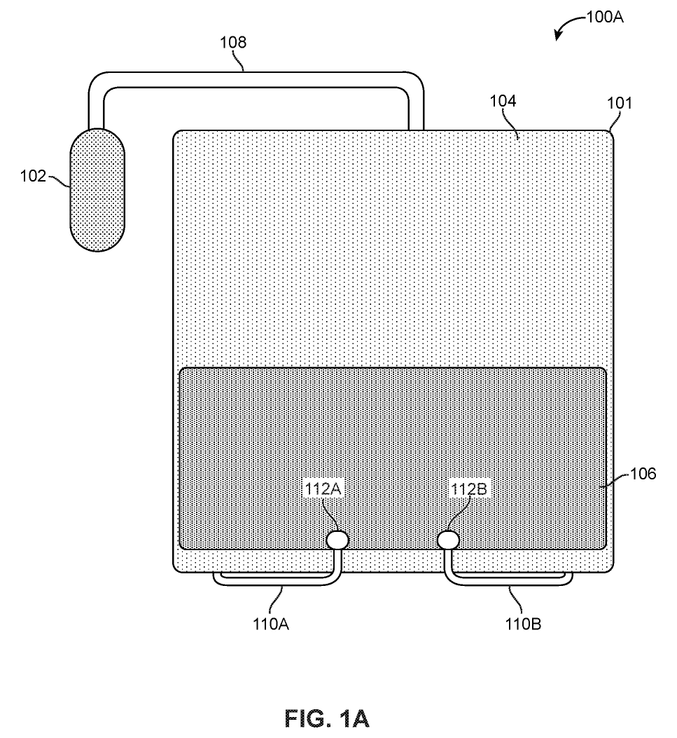

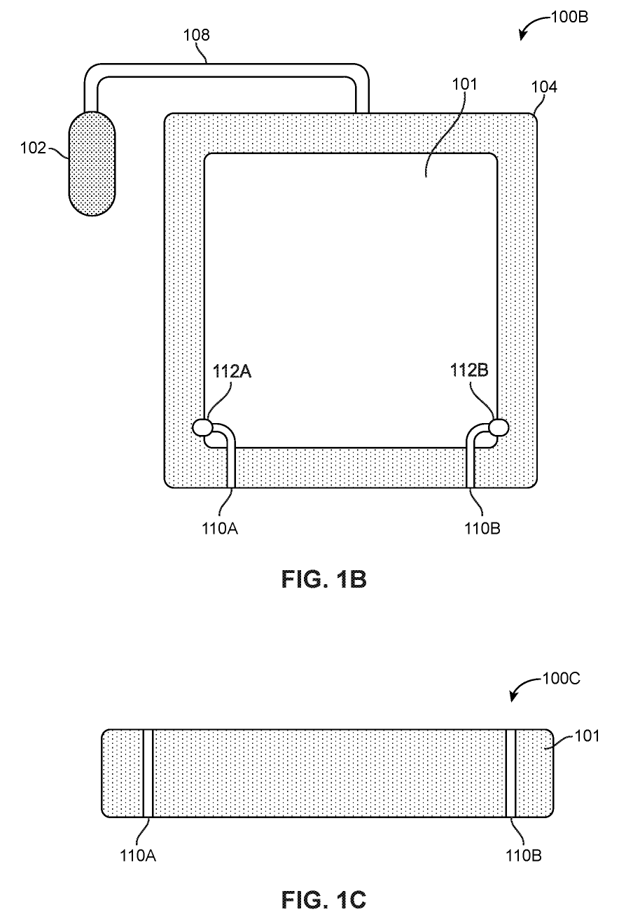

FIG. 1A shows a top view 100A of a mattress 101 with a cover 104 and blanket 106, according to some embodiments. The connections from a reservoir (e.g., hub 102) may be shown from the top view of the mattress 101. In some embodiments, the system may comprise a hub 102 that can be configured to regulate temperature of fluid flowing through the system. The hub 102 may be operatively coupled to the cover 104 through a cover umbilical 108, which may provide fluid communication between the hub 102 and the cover 104. The cover 104 and blanket 106 may be positioned on or adjacent to the mattress 101 to provide temperature regulation to a user’s body parts that may be in contact with the mattress 101.

FIG. 1B shows a bottom view 100B of the mattress 101. The bottom view may illustrate the underside configuration of mattress 101, which can include various components that may be positioned beneath the sleeping surface. In some embodiments, the bottom view may reveal structural elements that can support the temperature regulation system described herein.

The mattress cover 104 may be visible from the bottom view and can include features that may enhance the overall functionality of the bedding system. In some embodiments, the cover may comprise materials that can provide insulation properties while allowing for effective heat transfer from the fluid channels housed within the mattress structure. The bottom view configuration may show connection points or interfaces where the mattress can couple with other components of the temperature regulation system, such as umbilical cords or manifold connections.

The bottom view perspective may also show how the mattress cover 104 can be secured to the mattress body. The bottom view configuration may demonstrate how the temperature regulation system can be integrated into the mattress structure without compromising comfort or durability. In some embodiments, the bottom view may show access points or service areas that can allow for maintenance or inspection of the fluid circulation system. The mattress cover visible in the bottom view may comprise materials that can provide appropriate thermal conductivity properties to facilitate effective heat transfer between the circulating fluid and the user’s body.

FIG. 1C shows a foot view 100C of the mattress 101. Blanket umbilical 110A and blanket umbilical 110B may be visible in foot view 100C. In one embodiment, the blanket umbilical may connect the blanket 106 to the cover 104.

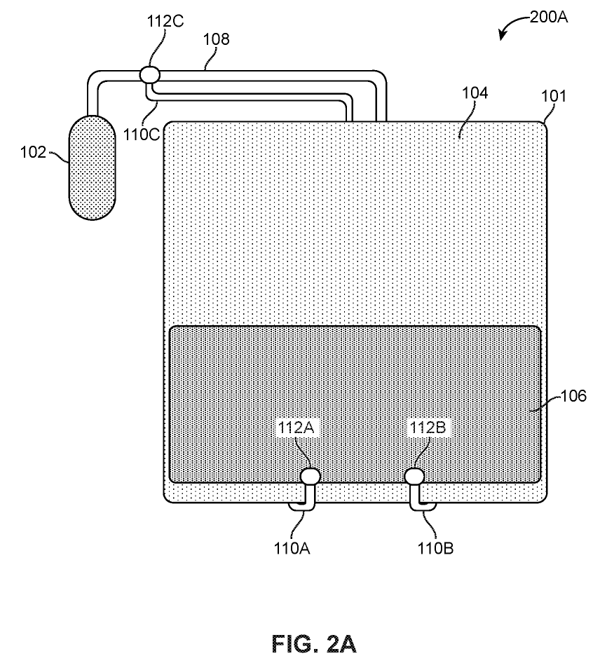

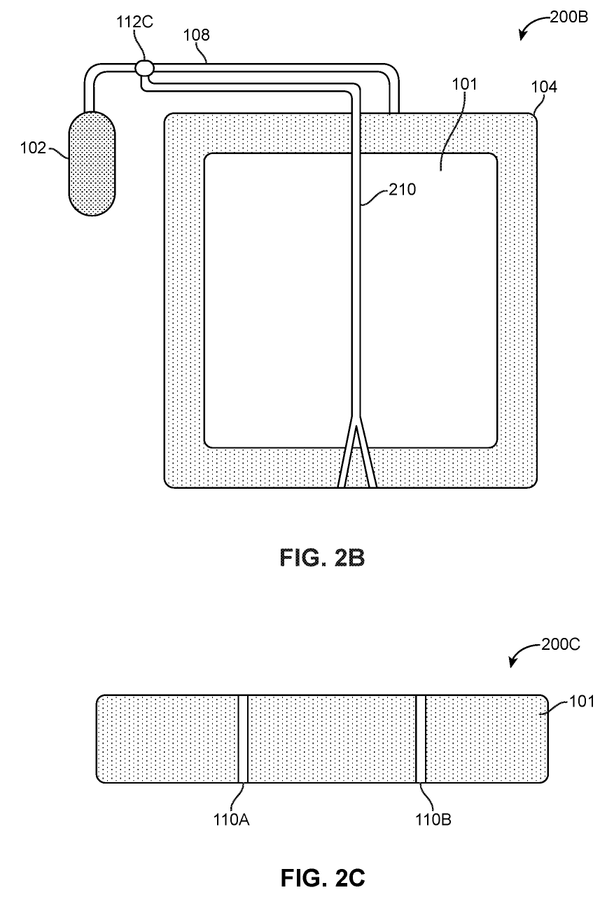

FIG. 2A shows a top view 200A of a mattress 101 with the mattress cover 104 and blanket 106. The connections from the reservoir (e.g., hub) are shown from the top view. In some embodiments, the system may comprise a configuration where fluid can flow from a reservoir to both a bed cover and a blanket through separate pathways. The top view may illustrate an exemplary arrangement where the reservoir may be positioned to provide fluid connections to multiple components of the bedding system. The reservoir, which may also be referred to as a hub, can be configured to supply temperature-regulated fluid to various elements of the system through one or more umbilical connections.

In some embodiments, the system may include a mattress 101 that can serve as a base component of the bedding arrangement. The mattress 101 may be configured to support a user and may work in conjunction with other temperature regulation components. A hub 102 may be positioned relative to the mattress to provide centralized fluid distribution capabilities. The hub 102 may house temperature regulation equipment and may serve as a control center for fluid circulation throughout the system.

The system may further comprise a cover 104 that can be positioned on or adjacent to the mattress 101. The cover 104 may include fluid channels configured to provide temperature regulation to areas in contact with or near a user’s body. In some embodiments, a blanket 106 may be configured to be placed over at least one body part of a user to provide additional temperature regulation. The blanket 106 may include a plurality of fluid channels housed within its structure, and these channels may be coupled to one or more manifolds as described herein.

The connection arrangement shown in the top view 200A may illustrate how fluid pathways can be established between the hub 102 and the various bedding components. In some embodiments, a cover umbilical 108 may provide fluid communication between the hub 102 and the cover 104. The cover umbilical 108 may be configured to direct temperature-regulated fluid from the hub 102 to fluid channels within the cover 104. Additionally, a blanket umbilical 110C may provide fluid communication between the hub 102 and the blanket 106. The blanket umbilical 110C may be configured to direct temperature-regulated fluid from the hub 102 to fluid channels within the blanket 106.

In some embodiments, the system may include coupling mechanisms 112A and 112B that can facilitate connections between different components. These couplings may provide secure and reversible connections that allow for easy assembly and disassembly of the system components. The couplings may incorporate magnetic elements or other securing means to ensure proper alignment and connection integrity.

The arrangement shown in top view 200A may demonstrate how the system can provide independent temperature control to different areas of the bedding system. The hub 102 may be configured with multiple outlets or may include flow control mechanisms that can direct different volumes or temperatures of fluid to the cover 104 and blanket 106 respectively. This configuration may allow users to customize temperature settings for different body regions or to optimize comfort based on individual preferences.

In some embodiments, the fluid pathways may be designed to minimize interference between the cover umbilical 108 and blanket umbilical 110C. The positioning and routing of these umbilicals provide efficient fluid flow while maintaining user comfort and system reliability. The connections from the reservoir may be strategically positioned to accommodate various mattress sizes and user configurations while ensuring consistent temperature regulation performance across the entire bedding system.

FIG. 2B shows a bottom view 200B of the mattress. The bottom view may illustrate an exemplary configuration of a bedding system described herein, where the mattress 101 can be positioned with the mattress cover 104 visible from underneath. In some embodiments, the bottom view may provide visibility of connection points and fluid channel routing that may not be apparent from other viewing angles. The mattress cover 104 may be configured to house fluid channels that can distribute temperature-regulated fluid across the surface area of the mattress. In some embodiments, the bottom view may show how the cover umbilical 108 can connect to the mattress cover 104 to provide fluid flow from a hub or reservoir system. The cover umbilical 108 may be positioned to optimize fluid distribution while minimizing interference with user comfort or mattress positioning. The mattress cover 104 may include multiple zones or regions that can receive different fluid flows or temperatures, allowing for customized temperature regulation across different areas of the sleeping surface. In some embodiments, the bottom view configuration may demonstrate how the fluid channels within the mattress cover 104 can be arranged to provide uniform temperature distribution while maintaining structural integrity of the cover. The connection points visible in the bottom view may include coupling mechanisms that can ensure secure fluid connections between the umbilical system and the mattress cover. These coupling mechanisms may incorporate magnetic elements or other securing means to facilitate easy connection and disconnection while maintaining fluid-tight seals during operation.

FIG. 2C shows a foot view 200C of the mattress 101. Blanket umbilical 110A and blanket umbilical 110B may be visible in foot view 200C. In one embodiment, the blanket umbilical 110A may connect the blanket 106 to the hub 102.

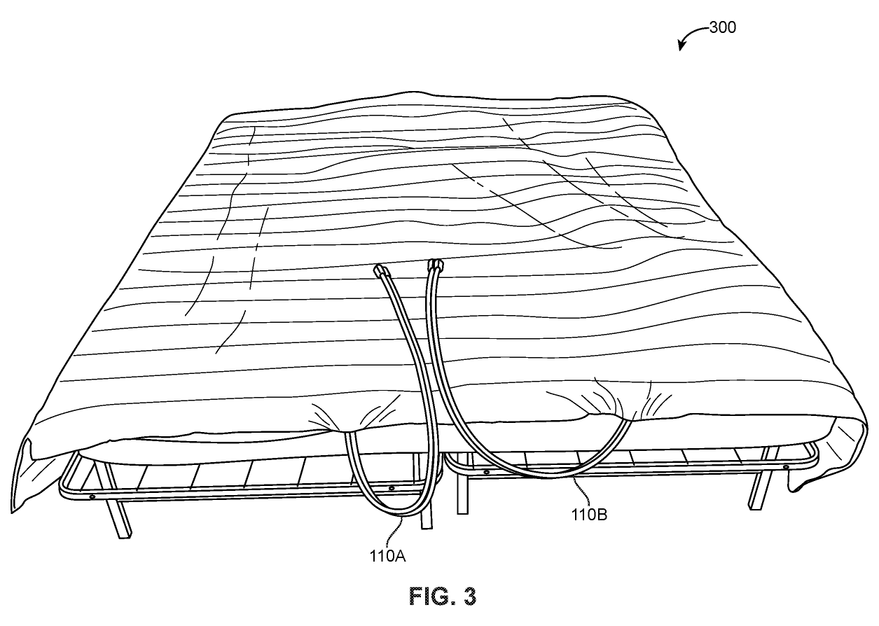

FIG. 3 shows a representation of a bedding system described herein. The bedding system may have two umbilical cords to provide connections from a reservoir (e.g., hub) to the bedding components. In some embodiments, the system may comprise a blanket 300 that can be configured to provide temperature regulation to a user. The blanket 300 may be fluidically connected to a temperature control system through multiple connection pathways.

The system may include a first umbilical cord and a second umbilical cord that can facilitate fluid flow between different components of the bedding system. In some embodiments, the first umbilical cord may be configured to direct temperature-regulated fluid from a reservoir to a first bedding component, while the second umbilical cord may be configured to direct fluid to a second bedding component or provide a return path for the fluid. The dual umbilical cord configuration may allow for enhanced temperature control and improved fluid distribution throughout the bedding system.

The blanket 300 may comprise a plurality of fluid channels housed within its structure, and these channels may be fluidically coupled to one or both of the umbilical cords. In some embodiments, the first umbilical cord and second umbilical cord may provide redundant fluid pathways to ensure consistent temperature regulation even if one pathway experiences reduced flow or blockage. The umbilical cord arrangement may also enable different zones of the blanket 300 to receive fluid at different temperatures or flow rates, allowing for customized temperature control across different areas of the bedding.

The reservoir or hub may be configured to supply temperature-regulated fluid through the first umbilical cord and second umbilical cord to maintain desired thermal conditions within the blanket 300. This dual-cord configuration may provide improved reliability and performance compared to single-cord systems, as it can offer backup fluid delivery pathways and enhanced thermal management capabilities for the overall bedding system.

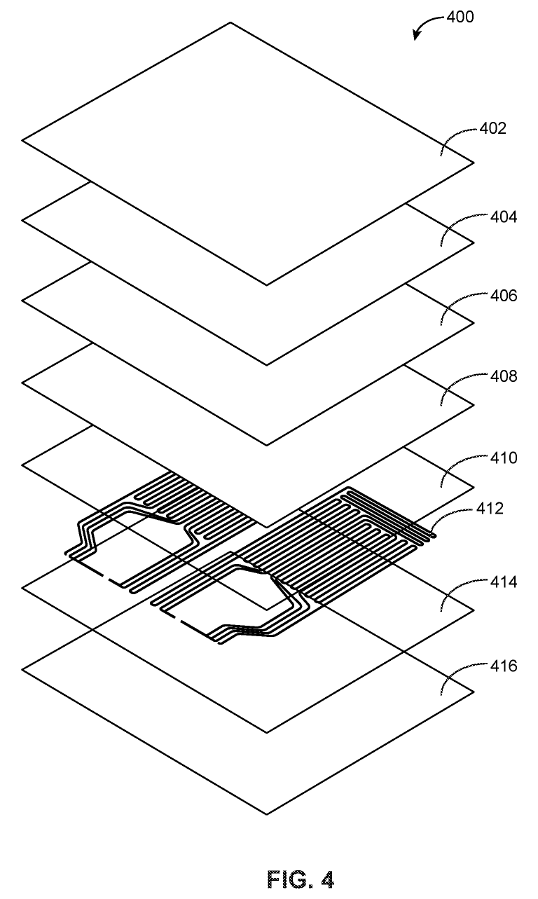

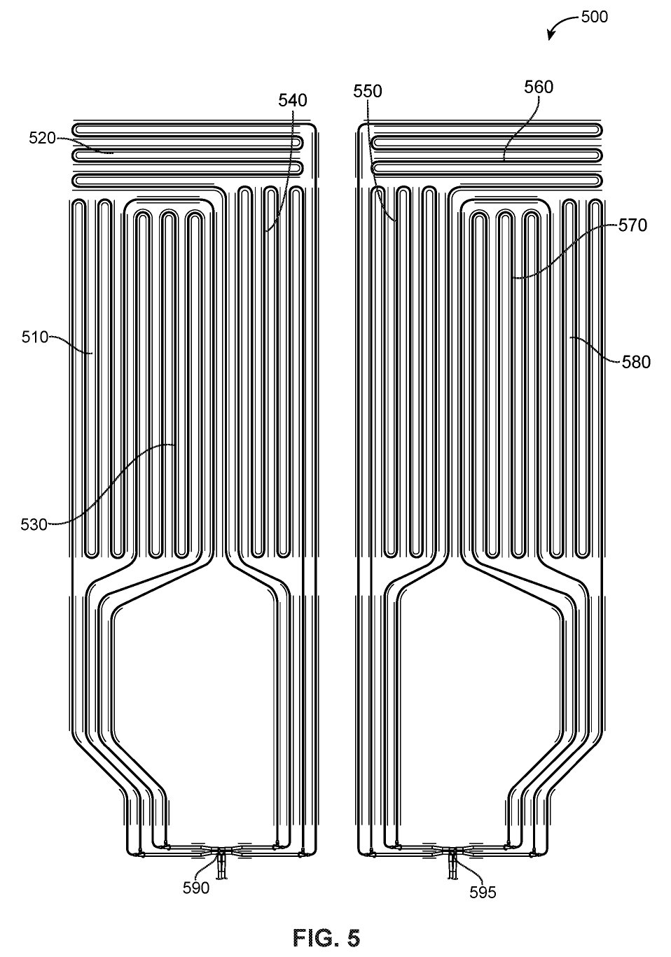

FIG. 4 shows an exemplary layer structure of the bedding. Blanket 400 may comprise multiple layers that can increase comfort, insulation, and quality of thermoregulation. In some embodiments, the layers may be arranged from top to bottom and may include top face 402, top face lining 404, top filling 406, top quilt lining 408, middle face 410, tube body 412, middle back 414, and bottom face 416. The layer structure may provide enhanced thermal performance and improved user comfort through strategic material placement and construction.

Top face 402 may serve as the outermost layer that faces away from the user during use (e.g., when the user is in bed with the blanket on top of them). This layer may be constructed from materials that provide durability and aesthetic appeal while maintaining thermal properties. Top face lining 404 may be positioned beneath top face 402 and can provide additional structural support and thermal regulation capabilities. The lining may comprise materials selected for their thermal conductivity properties and comfort characteristics.

Top filling 406 may be disposed between the lining layers and can provide insulation and comfort enhancement. This filling layer may comprise materials such as synthetic fibers, down alternatives, or other insulating materials that contribute to the overall thermal performance of blanket 400. Top quilt lining 408 may be positioned below top filling 406 and can help contain the filling material while providing a smooth interface with the underlying layers.

Middle face 410 may serve as an intermediate layer that can facilitate thermal transfer between the upper layers and the fluid channel system. This layer may be constructed from materials that optimize heat conduction while maintaining structural integrity. Tube body 412 may house the plurality of fluid channels and can be configured to distribute temperature-regulated fluid throughout blanket 400. The tube body may comprise flexible materials that allow for comfortable user interaction while maintaining fluid flow integrity.

Middle back 414 may be positioned beneath tube body 412 and can provide structural support for the fluid channel system. This layer may help maintain proper spacing and positioning of the fluid channels during use. Bottom face 416 may serve as the innermost layer that contacts the user during operation. This layer may be constructed from materials that optimize thermal transfer to the user while providing comfort and durability.

The multi-layer construction of blanket 400 may allow for optimized thermal performance by creating distinct zones for insulation, thermal conduction, and user comfort. Each layer may be selected and positioned to contribute to the overall effectiveness of the temperature regulation system while maintaining the flexibility and comfort characteristics desired in bedding applications. The arrangement of these layers may also facilitate manufacturing processes and allow for customization of thermal properties based on user preferences or specific application requirements.

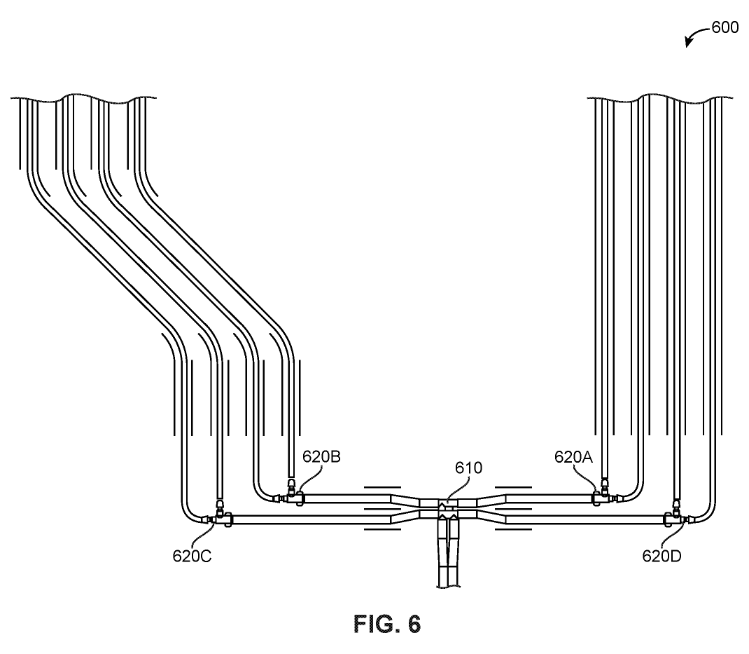

FIG. 5 shows an exemplary arrangement of channels and zones of a bedding 500 (e.g., blanket) described herein, according to some embodiments. The arrangement can comprise a plurality of zones of the blanket and a plurality of respective channels. For example, the arrangement has eight zones of the blanket and eight channels of a plurality of channels, with a first zone 510, second zone 520, third zone 530, fourth zone 540, fifth zone 550, sixth zone 560, seventh zone 570, and eighth zone 580. As an example, the third zone 530 and sixth zone 560 are in a horizontal orientation. As an example, the third zone 530 and sixth zone 560 are near an upper region (e.g., near a head and/or chin of a user). Any number of channels can be connected to one or more manifolds described herein. In this example, the channels comprising the first zone 510, second zone 520, third zone 530, and fourth zone 540 are connected to a first manifold 590, and the fifth zone 550, sixth zone 560, seventh zone 570, and eighth zone 580 are connected to a second manifold 595.

The tube arrangement shown may provide improved water flow to the bedding and may reduce blockages in the tubes. The arrangement in FIG. 5 may demonstrate how eight zones of the blanket and eight channels can be configured to optimize thermal performance and user comfort. Each zone may be strategically positioned to correspond to different body regions of a user, allowing for targeted temperature regulation. The manifold connections may help distribute fluid flow evenly across the zones while minimizing the risk of overlapping tubes that could cause discomfort or reduced performance.

The fluid channels (e.g., tubes) may measure a cross-sectional dimension (e.g., diameter). In some embodiments, the cross-sectional dimension (e.g., diameter) of the fluid channels (e.g., tubes) of the bedding (e.g., blanket) may be at least about 3 millimeters (mm), at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, at least about 9.5 mm, or greater than about 10 mm. In some embodiments, the cross-sectional dimension (e.g., diameter) of the fluid channels (e.g., tubes) of the bedding (e.g., blanket) may be at most about 10 mm, at most about 9.5 mm, at most about 9 mm, at most about 8.5 mm, at most about 8 mm, at most about 7.5 mm, at most about 7 mm, at most about 6.5 mm, at most about 6 mm, at most about 5.5 mm, at most about 5 mm, at most about 4.5 mm, at most about 4 mm, at most about 3.5 mm, at most about 3 mm, or less than about 3 mm. In some embodiments, the cross-sectional dimension (e.g., diameter) of the fluid channels (e.g., tubes) of the bedding (e.g., blanket) may be from about 3 mm to about 10 mm. In some embodiments, the cross-sectional dimension (e.g., diameter) of the channels (e.g., tubes) of the bedding (e.g., blanket) may be from about 3 mm to about 4 mm, about 3 mm to about 5 mm, about 3 mm to about 5.5 mm, about 3 mm to about 6 mm, about 3 mm to about 6.5 mm, about 3 mm to about 7 mm, about 3 mm to about 7.5 mm, about 3 mm to about 8 mm, about 3 mm to about 8.5 mm, about 3 mm to about 9 mm, about 3 mm to about 10 mm, about 4 mm to about 5 mm, about 4 mm to about 5.5 mm, about 4 mm to about 6 mm, about 4 mm to about 6.5 mm, about 4 mm to about 7 mm, about 4 mm to about 7.5 mm, about 4 mm to about 8 mm, about 4 mm to about 8.5 mm, about 4 mm to about 9 mm, about 4 mm to about 10 mm, about 5 mm to about 5.5 mm, about 5 mm to about 6 mm, about 5 mm to about 6.5 mm, about 5 mm to about 7 mm, about 5 mm to about 7.5 mm, about 5 mm to about 8 mm, about 5 mm to about 8.5 mm, about 5 mm to about 9 mm, about 5 mm to about 10 mm, about 5.5 mm to about 6 mm, about 5.5 mm to about 6.5 mm, about 5.5 mm to about 7 mm, about 5.5 mm to about 7.5 mm, about 5.5 mm to about 8 mm, about 5.5 mm to about 8.5 mm, about 5.5 mm to about 9 mm, about 5.5 mm to about 10 mm, about 6 mm to about 6.5 mm, about 6 mm to about 7 mm, about 6 mm to about 7.5 mm, about 6 mm to about 8 mm, about 6 mm to about 8.5 mm, about 6 mm to about 9 mm, about 6 mm to about 10 mm, about 6.5 mm to about 7 mm, about 6.5 mm to about 7.5 mm, about 6.5 mm to about 8 mm, about 6.5 mm to about 8.5 mm, about 6.5 mm to about 9 mm, about 6.5 mm to about 10 mm, about 7 mm to about 7.5 mm, about 7 mm to about 8 mm, about 7 mm to about 8.5 mm, about 7 mm to about 9 mm, about 7 mm to about 10 mm, about 7.5 mm to about 8 mm, about 7.5 mm to about 8.5 mm, about 7.5 mm to about 9 mm, about 7.5 mm to about 10 mm, about 8 mm to about 8.5 mm, about 8 mm to about 9 mm, about 8 mm to about 10 mm, about 8.5 mm to about 9 mm, about 8.5 mm to about 10 mm, or about 9 mm to about 10 mm.

The fluid channels of the plurality of channels may comprise a thermoplastic, a thermoplastic elastomer (TPE), silicone, or polyvinyl chloride (PVC). In some embodiments, the fluid channels of the plurality of channels may comprise one or more of a thermoplastic, a thermoplastic elastomer (TPE), silicone, or polyvinyl chloride (PVC). In some embodiments, the TPE comprises a polyamide thermoplastic elastomer (TPA), a polystyrene thermoplastic elastomer (TPS), a polyurethane thermoplastic elastomer (TPU), an olefinic thermoplastic elastomer (TPO), a polyester thermoplastic elastomer (TPEE), a crosslinked thermoplastic rubber (TPV), or any combination thereof.

Channels (e.g., tubes) of the plurality of channels may be spaced apart from one another. In some embodiments, a first channel (e.g., a first tube) may be spaced at least about 5 mm, at least about 10 mm, at least about 15 mm, at least about 20 mm, at least about 25 mm, at least about 30 mm, at least about 35 mm, at least about 40 mm, at least about 45 mm, at least about 50 mm, at least about 60 mm, at least about 70 mm, at least about 80 mm, at least about 90 mm, at least about 100 mm, or greater than 100 mm apart from a second channel (e.g., a second tube). In some embodiments, a first channel (e.g., a first tube) may be spaced at most about 100 mm, at most about 90 mm, at most about 80 mm, at most about 70 mm, at most about 60 mm, at most about 50 mm, at most about 45 mm, at most about 40 mm, at most about 35 mm, at most about 30 mm, at most about 25 mm, at most about 20 mm, at most about 15 mm, at most about 10 mm, at most about 5 mm, or less than about 5 mm apart from a second channel (e.g., a second tube). In some embodiments, a first channel (e.g., a first tube) may be spaced from about 5 mm to about 100 mm apart from a second channel (e.g., a second tube). In some embodiments, a first channel (e.g., a first tube) may be spaced from about 5 mm to about 10 mm, about 5 mm to about 15 mm, about 5 mm to about 20 mm, about 5 mm to about 25 mm, about 5 mm to about 30 mm, about 5 mm to about 40 mm, about 5 mm to about 50 mm, about 5 mm to about 60 mm, about 5 mm to about 70 mm, about 5 mm to about 80 mm, about 5 mm to about 100 mm, about 10 mm to about 15 mm, about 10 mm to about 20 mm, about 10 mm to about 25 mm, about 10 mm to about 30 mm, about 10 mm to about 40 mm, about 10 mm to about 50 mm, about 10 mm to about 60 mm, about 10 mm to about 70 mm, about 10 mm to about 80 mm, about 10 mm to about 100 mm, about 15 mm to about 20 mm, about 15 mm to about 25 mm, about 15 mm to about 30 mm, about 15 mm to about 40 mm, about 15 mm to about 50 mm, about 15 mm to about 60 mm, about 15 mm to about 70 mm, about 15 mm to about 80 mm, about 15 mm to about 100 mm, about 20 mm to about 25 mm, about 20 mm to about 30 mm, about 20 mm to about 40 mm, about 20 mm to about 50 mm, about 20 mm to about 60 mm, about 20 mm to about 70 mm, about 20 mm to about 80 mm, about 20 mm to about 100 mm, about 25 mm to about 30 mm, about 25 mm to about 40 mm, about 25 mm to about 50 mm, about 25 mm to about 60 mm, about 25 mm to about 70 mm, about 25 mm to about 80 mm, about 25 mm to about 100 mm, about 30 mm to about 40 mm, about 30 mm to about 50 mm, about 30 mm to about 60 mm, about 30 mm to about 70 mm, about 30 mm to about 80 mm, about 30 mm to about 100 mm, about 40 mm to about 50 mm, about 40 mm to about 60 mm, about 40 mm to about 70 mm, about 40 mm to about 80 mm, about 40 mm to about 100 mm, about 50 mm to about 60 mm, about 50 mm to about 70 mm, about 50 mm to about 80 mm, about 50 mm to about 100 mm, about 60 mm to about 70 mm, about 60 mm to about 80 mm, about 60 mm to about 100 mm, about 70 mm to about 80 mm, about 70 mm to about 100 mm, or about 80 mm to about 100 mm apart from a second channel (e.g., a second tube).

A density of the plurality of fluid channels along an area of the bedding (e.g., blanket) may be non-uniform. A density of the plurality of fluid channels along an area of the bedding (e.g., blanket) may be uniform. In some embodiments, a density of the plurality of fluid channels within an area of the blanket may be non-uniform. A density of the plurality of fluid channels within an area of the blanket may be uniform. In some embodiments, the bedding may comprise an upper region and a lower region. In some embodiments, there may be a same density of fluid channels in an upper region and lower region. In some embodiments, there may be different densities of fluid channels in an upper region and lower region. For example, there may be less fluid channels (e.g., tubes) in an upper region of the bedding compared to that of a lower region of the bedding. As another example, there may be more fluid channels (e.g., tubes) in an upper region of the bedding compared to that of a lower region of the bedding. Without wishing to be bound by theory, a distribution of fluid channels may enhance a thermal performance (e.g., thermal transfer) of the bedding.

In some cases, a first zone of the blanket may comprise one or more first fluid channels and a second zone of the blanket may comprise one or more second fluid channels. A density of the first fluid channels in an area of the first zone and a density of the second fluid channels in an area of the second zone may be different as compared to one another by at least about, at most about, or about 5%, 10%, 15%, 20%, 25%, 30%, 35%, 40%, 45%, 50%, 60%, 70%, 80%, 90%, 95%, 96%, 97%, 98%, or 99%.

In some embodiments, a portion of the bedding (e.g., blanket) may correspond to a lower body of the user. In some embodiments, a portion of the bedding (e.g., blanket) may correspond to an upper body of the user. In some embodiments, a portion of the bedding (e.g., blanket) corresponding to a lower body of the user may have a lower density of the plurality of fluid channels as compared to an additional portion of the blanket corresponding to an upper body of the user. In some embodiments, a portion of the bedding (e.g., blanket) corresponding to a lower body of the user may have a higher density of the plurality of fluid channels as compared to an additional portion of the blanket corresponding to an upper body of the user. In some embodiments, a portion of the bedding (e.g., blanket) corresponding to a lower body of the user may have a similar density of the plurality of fluid channels as compared to an additional portion of the blanket corresponding to an upper body of the user.

In some embodiments, the system may comprise an elongate support member. The elongate support member described herein may comprise a textile material. The elongate support member may be a rope, a cord, a tube, a string, a foam, a thread, a ribbon, or any combination thereof. The elongate support member may increase a uniformity of the bedding. Without wishing to be bound by theory, the elongate support member may increase a comfort of the bedding and/or improve fluid flow of the channels. In some embodiments, the elongate support member may have a similar cross-sectional dimension (e.g., diameter) to that of a channel of the plurality of channels. In some embodiments, the elongate support member may have a smaller cross-sectional dimension (e.g., diameter) compared to that of a channel of the plurality of channels. In some embodiments, the elongate support member may have a larger cross-sectional dimension (e.g., diameter) compared to that of a channel of the plurality of channels. The elongate support member can be placed in between a first channel (e.g., a first tube) and a second channel (e.g., a second tube). The elongate support member may not be configured to direct flow of a fluid (e.g., a temperature-regulated fluid).

The elongate support member may measure a cross-sectional dimension (e.g., diameter). In some embodiments, the cross-sectional dimension (e.g., diameter) of the elongate support member may be at least about 3 millimeters (mm), at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, at least about 9.5 mm, or greater than about 10 mm. In some embodiments, the cross-sectional dimension (e.g., diameter) of the elongate support member may be at most about 10 mm, at most about 9.5 mm, at most about 9 mm, at most about 8.5 mm, at most about 8 mm, at most about 7.5 mm, at most about 7 mm, at most about 6.5 mm, at most about 6 mm, at most about 5.5 mm, at most about 5 mm, at most about 4.5 mm, at most about 4 mm, at most about 3.5 mm, at most about 3 mm, or less than about 3 mm. In some embodiments, the cross-sectional dimension (e.g., diameter) of the elongate support member may be from about 3 mm to about 10 mm. In some embodiments, the cross-sectional dimension (e.g., diameter) of the elongate support member may be from about 3 mm to about 4 mm, about 3 mm to about 5 mm, about 3 mm to about 5.5 mm, about 3 mm to about 6 mm, about 3 mm to about 6.5 mm, about 3 mm to about 7 mm, about 3 mm to about 7.5 mm, about 3 mm to about 8 mm, about 3 mm to about 8.5 mm, about 3 mm to about 9 mm, about 3 mm to about 10 mm, about 4 mm to about 5 mm, about 4 mm to about 5.5 mm, about 4 mm to about 6 mm, about 4 mm to about 6.5 mm, about 4 mm to about 7 mm, about 4 mm to about 7.5 mm, about 4 mm to about 8 mm, about 4 mm to about 8.5 mm, about 4 mm to about 9 mm, about 4 mm to about 10 mm, about 5 mm to about 5.5 mm, about 5 mm to about 6 mm, about 5 mm to about 6.5 mm, about 5 mm to about 7 mm, about 5 mm to about 7.5 mm, about 5 mm to about 8 mm, about 5 mm to about 8.5 mm, about 5 mm to about 9 mm, about 5 mm to about 10 mm, about 5.5 mm to about 6 mm, about 5.5 mm to about 6.5 mm, about 5.5 mm to about 7 mm, about 5.5 mm to about 7.5 mm, about 5.5 mm to about 8 mm, about 5.5 mm to about 8.5 mm, about 5.5 mm to about 9 mm, about 5.5 mm to about 10 mm, about 6 mm to about 6.5 mm, about 6 mm to about 7 mm, about 6 mm to about 7.5 mm, about 6 mm to about 8 mm, about 6 mm to about 8.5 mm, about 6 mm to about 9 mm, about 6 mm to about 10 mm, about 6.5 mm to about 7 mm, about 6.5 mm to about 7.5 mm, about 6.5 mm to about 8 mm, about 6.5 mm to about 8.5 mm, about 6.5 mm to about 9 mm, about 6.5 mm to about 10 mm, about 7 mm to about 7.5 mm, about 7 mm to about 8 mm, about 7 mm to about 8.5 mm, about 7 mm to about 9 mm, about 7 mm to about 10 mm, about 7.5 mm to about 8 mm, about 7.5 mm to about 8.5 mm, about 7.5 mm to about 9 mm, about 7.5 mm to about 10 mm, about 8 mm to about 8.5 mm, about 8 mm to about 9 mm, about 8 mm to about 10 mm, about 8.5 mm to about 9 mm, about 8.5 mm to about 10 mm, or about 9 mm to about 10 mm.

In some embodiments, a cross-sectional dimension (e.g., diameter) of the elongate support member may be the same or substantially the same as a cross-sectional dimension (e.g., diameter) of a channel. In some embodiments, a cross-sectional dimension (e.g., diameter) of the elongate support member may be different from a cross-sectional dimension (e.g., diameter) of a channel by at least about 5%, at least about 10%, at least about 15%, at least about 20%, at least about 25%, at least about 30%, at least about 40%, at least about 50%, at least about 75%, or greater than about 75%. In some embodiments, a cross-sectional dimension (e.g., diameter) of the elongate support member may be different from a cross-sectional dimension (e.g., diameter) of a channel by at most about 75%, at most about 50%, at most about 40%, at most about 30%, at most about 25%, at most about 20%, at most about 15%, at most about 10%, at most about 5%, or less than about 5%. For example, a cross-sectional dimension (e.g., diameter) of the elongate support member may be about 3 millimeters (mm) and a cross-sectional dimension (e.g., diameter) of a channel may be about 4 mm. In some embodiments, a cross-sectional dimension (e.g., diameter) of the elongate support member may be different from a cross-sectional dimension (e.g., diameter) of a channel by a measure from about 5% to about 75%. In some embodiments, a cross-sectional dimension (e.g., diameter) of the elongate support member may be different from a cross-sectional dimension (e.g., diameter) of a channel by a measure from about 5% to about 10%, about 5% to about 15%, about 5% to about 20%, about 5% to about 25%, about 5% to about 30%, about 5% to about 35%, about 5% to about 40%, about 5% to about 45%, about 5% to about 50%, about 5% to about 60%, about 5% to about 75%, about 10% to about 15%, about 10% to about 20%, about 10% to about 25%, about 10% to about 30%, about 10% to about 35%, about 10% to about 40%, about 10% to about 45%, about 10% to about 50%, about 10% to about 60%, about 10% to about 75%, about 15% to about 20%, about 15% to about 25%, about 15% to about 30%, about 15% to about 35%, about 15% to about 40%, about 15% to about 45%, about 15% to about 50%, about 15% to about 60%, about 15% to about 75%, about 20% to about 25%, about 20% to about 30%, about 20% to about 35%, about 20% to about 40%, about 20% to about 45%, about 20% to about 50%, about 20% to about 60%, about 20% to about 75%, about 25% to about 30%, about 25% to about 35%, about 25% to about 40%, about 25% to about 45%, about 25% to about 50%, about 25% to about 60%, about 25% to about 75%, about 30% to about 35%, about 30% to about 40%, about 30% to about 45%, about 30% to about 50%, about 30% to about 60%, about 30% to about 75%, about 35% to about 40%, about 35% to about 45%, about 35% to about 50%, about 35% to about 60%, about 35% to about 75%, about 40% to about 45%, about 40% to about 50%, about 40% to about 60%, about 40% to about 75%, about 45% to about 50%, about 45% to about 60%, about 45% to about 75%, about 50% to about 60%, about 50% to about 75%, or about 60% to about 75%.

In some embodiments, the bedding (e.g., blanket) comprises one or more layers. In some embodiments, the bedding (e.g., blanket) comprises three or more layers. In some embodiments, the bedding (e.g., blanket) comprises 2, 3, 4, 5, 6, 7, 8, or more layers (e.g., fabric layers). The bedding (e.g., blanket) may comprise a lining. The bedding (e.g., blanket) may comprise layers to hold the plurality of channels in place. The layers of the bedding (e.g., blanket) may be a fabric. In some embodiments, the one or more layers may be cotton, polyester, viscose, synthetic blends, or any combination thereof. The type of fabric(s) of the one or more layers may improve a thermal performance of the bedding (e.g., blanket). The type of fabric(s) of the one or more layers may improve an air flow permeability.

In some embodiments, the system may comprise a first layer (e.g., a first fabric layer) disposed above the plurality of fluid channels. The system may comprise a second layer (e.g., a second fabric layer) disposed below the plurality of fluid channels. The first layer and the second layer may be the same material (e.g., the same fabric). The first layer and the second layer may be different materials (e.g., different fabrics). The first layer of the bedding and the second layer of the bedding may be connected. The connection may be by stitching, buttons, magnets, Velcro, or combinations thereof. The first layer and the second layer may be stitched together. Without wishing to be bound by theory, the first layer and the second layer may be stitched together to partially hold the plurality of fluid channels.

In some embodiments, the bedding (e.g., blanket) may comprise a bottom side. The bottom side may be configured to be in contact with at least one body part of a user. In some embodiments, the bedding (e.g., blanket) may comprise a top side. The top side of the bedding (e.g., blanket) may be opposite a bottom side of the bedding. In some embodiments, the top side of the bedding (e.g., blanket) and the bottom side of the bedding (e.g., blanket) may exhibit similar heat transfer coefficient values. In some embodiments, the top side of the bedding (e.g., blanket) and the bottom side of the bedding (e.g., blanket) may exhibit different heat transfer coefficient values. In some embodiments, the top side of the bedding (e.g., blanket) and/or the bottom side of the bedding (e.g., blanket) may exhibit a heat transfer coefficient value of at least about 10 W/(m²K), at least about 50 W/(m²K), at least about 100 W/(m²K), at least about 200 W/(m²K), at least about 300 W/(m²K), at least about 400 W/(m²K), at least about 500 W/(m²K), at least about 1000 W/(m²K), at least about 2000 W/(m²K), at least about 3000 W/(m²K), at least about 4000 W/(m²K), at least about 5000 W/(m²K), at least about 10000 W/(m²K), or greater than about 10,000 W/(m²K). In some embodiments, the top side of the bedding (e.g., blanket) and/or the bottom side of the bedding (e.g., blanket) may exhibit a heat transfer coefficient value of at most about 10000 W/(m²K), at most about 5000 W/(m²K), at most about 4000 W/(m²K), at most about 3000 W/(m²K), at most about 2000 W/(m²K), at most about 1000 W/(m²K), at most about 500 W/(m²K), at most about 400 W/(m²K), at most about 300 W/(m²K), at most about 200 W/(m²K), at most about 100 W/(m²K), at most about 50 W/(m²K), at most about 10 W/(m²K), or less than about 10 W/(m²K). In some embodiments, a difference in the heat transfer coefficient value of a top side and bottom side of the bedding (e.g., blanket) described herein may be at least about 10 W/(m²K), at least about 20 W/(m²K), at least about 30 W/(m²K), at least about 40 W/(m²K), at least about 50 W/(m²K), at least about 60 W/(m²K), at least about 70 W/(m²K), at least about 80 W/(m²K), at least about 90 W/(m²K), at least about 100 W/(m²K), or greater than about 100 W/(m²K). In some embodiments, a difference in the heat transfer coefficient value of a top side and bottom side of the bedding (e.g., blanket) described herein may be at most about 100 W/(m²K), at most about 90 W/(m²K), at most about 80 W/(m²K), at most about 70 W/(m²K), at most about 60 W/(m²K), at most about 50 W/(m²K), at most about 40 W/(m²K), at most about 30 W/(m²K), at most about 20 W/(m²K), at most about 10 W/(m²K), or less than about 10 W/(m²K).

In some embodiments, a manifold may be housed within the bedding (e.g., blanket). In some embodiments, a manifold may be housed outside of the bedding (e.g., blanket). In some embodiments, the system may comprise two or more manifolds, in which one or more manifolds may be housed within the bedding and one or more manifolds may be housed outside of the bedding. The plurality of channels may be connected. In some embodiments, the plurality of channels may be connected by one or more manifolds (e.g., 1, 2, 3, 4, 5, or more manifolds). The manifold may be present at an upper region of the bedding, a lower region of the bedding, or any combination thereof. A manifold connection may help avoid overlapping of channels (e.g., tubes). The one or more manifolds may be positioned relative to one or more body parts of a user. For example, the one or more manifolds may be positioned near a user’s foot or leg. The manifold may be a distributed manifold or a flexible manifold. In some embodiments, the system may comprise one or more fluid ports (e.g., 1, 2, 3, 4, 5, or more fluid ports). The fluid port may be in fluid communication with a manifold. In some embodiments, the fluid port may be configured to couple or reversibly couple to a channel (e.g., an inlet fluid channel). The channel (e.g., inlet fluid channel) may be configured to direct a flow of fluid (e.g., temperature-regulated fluid). As an example, the fluid port may be configured to reversibly couple to an inlet fluid channel configured to direct flow of the temperature-regulated fluid through the fluid port and towards a manifold.

In some embodiments, the fluid port and/or the channel (e.g., inlet fluid channel) may comprise a magnet. In some embodiments, the fluid port and/or the channel (e.g., inlet fluid channel) may comprise one or more magnets (e.g., 1, 2, 3, 4, 5, or more magnets). A magnet may help assess a connection between the bedding and the reservoir. A magnet may help assess a connection between the bedding and another bed device (e.g., a mattress, or mattress cover). The magnet may provide the reversible coupling between the fluid port and the channel (e.g., inlet fluid channel). The system may comprise a sensor (e.g., a magnetic field sensor). The sensor (e.g., a magnetic field sensor) may be disposed by a fluid port. The sensor (e.g., a magnetic field sensor) may be disposed adjacent to a fluid port. The sensor (e.g., a magnetic field sensor) may be disposed adjacent to a channel (e.g., inlet fluid channel). In some embodiments, the sensor (e.g., a magnetic field sensor) may be disposed adjacent to a fluid port and a channel (e.g., inlet fluid channel). The sensor (e.g., a magnetic field sensor) may be configured to detect a reversible coupling. For example, the sensor (e.g., a magnetic field sensor) may be configured to detect a reversible coupling between a fluid port and channel (e.g., inlet fluid channel) of the system described herein.

In some embodiments, the system may comprise a sensor. The system may comprise one or more sensors (e.g., 1, 2, 3, 4, 5, 6, or more sensors). The one or more sensors may comprise a capacitance sensor, a temperature sensor, a pressure sensor, a piezo sensor, or any combination thereof. The sensor may detect a biological signal of a user. The sensor may detect a temperature or characteristic of the fluid. In some embodiments, the fluid may be a liquid. In some embodiments, the fluid may be a gas. In some embodiments, the fluid of a first zone of the bedding (e.g., blanket) may be the same as a fluid of a second zone of the bedding (e.g., blanket). In some embodiments, the fluid of a first zone of the bedding (e.g., blanket) may be different from a fluid of a second zone of the bedding (e.g., blanket). In some embodiments, the system may comprise a fluid flow controller. In some embodiments, the system may not comprise a fluid flow controller. In some embodiments, the fluid flow controller may be a pump, a valve, a gate, or any combination thereof. In some embodiments, the system may not have a pump. In some embodiments, the system may not have a valve. In some embodiments, the system may not have a gate. In some embodiments, the system may have one or more pumps (e.g., 1, 2, 3, 4, 5, or more pumps). In some embodiments, the system may have one or more valves (e.g., 1, 2, 3, 4, 5, or more valves). In some embodiments, the system may have one or more gates (e.g., 1, 2, 3, 4, 5, or more gates). The one or more zones of the bedding (e.g., blanket) of the bedding may comprise different fluid flows in the channels. The system may comprise one or more connectors (e.g., adaptors). A connector (e.g., adaptor) may connect the bedding to a reservoir. In some embodiments, a connector (e.g., adaptor) may connect the bedding to another bed device (e.g., a mattress, or mattress cover). In some embodiments, the bedding may be a blanket, a comforter, a duvet, a quilt, a coverlet, or a bedspread.

The plurality of fluid channels may be disposed on a side of the bedding (e.g., blanket). In some embodiments, the system may comprise an additional fluid port. The additional fluid port may be in fluid communication with one or more fluid channels of the plurality of fluid channels. In some embodiments, the additional fluid port may be in fluid communication with one or more fluid channels disposed on a different side of the bedding (e.g., blanket). A fluid port and an additional fluid port may exhibit opposite magnetic polarities.

In some embodiments, the system may comprise a bed cover. The bed cover may be configured to be placed under at least one body part of the user. The bed cover may be placed under the same body part of the user that the bedding (e.g., blanket) is placed on top of. The bed cover may be placed under a different body part of the user that the bedding (e.g., blanket) is placed on top of. The bed cover may provide additional temperature regulation to a body part of the user. The bed cover may be placed under a head of the user, neck of the user, torso of the user, arm of the user, hand of the user, leg of the user, foot of the user, or combination thereof. In some embodiments, a bed cover and a bedding (e.g., blanket) may be regulated at the same temperature. In some embodiments, a bed cover and a bedding (e.g., blanket) may be regulated at different temperatures. In some embodiments, the bed cover may be configured to be placed under the at least one body part of the user to provide an additional temperature regulation to the at least one body part of the user. In some embodiments, a temperature of the bed cover and a temperature of the bedding (e.g., blanket) may be different by at least about 0.5° C, at least about 1° C, at least about 2° C, at least about 3° C, at least about 4° C, at least about 5° C, at least about 6° C, at least about 7° C, at least about 8° C, at least about 9° C, at least about 10° C, at least about 15° C, or greater than about 15° C. In some embodiments, a temperature of the bed cover and a temperature of the bedding (e.g., blanket) may be different by at most about 15° C, at most about 10° C, at most about 9° C, at most about 8° C, at most about 7° C, at most about 6° C, at most about 5° C, at most about 4° C, at most about 3° C, at most about 2° C, at most about 1° C, at most about 0.5° C, or less than about 0.5° C.

In some embodiments, a temperature of the bed cover and a temperature of the bedding (e.g., blanket) may be different by a range from about 0.1 °C to about 10 °C. In some embodiments, a temperature of the bed cover and a temperature of the bedding (e.g., blanket) may be different by a range from about 0.1 °C to about 0.5 °C, about 0.1 °C to about 1 °C, about 0.1 °C to about 2 °C, about 0.1 °C to about 3 °C, about 0.1 °C to about 4 °C, about 0.1 °C to about 5 °C, about 0.1 °C to about 6 °C, about 0.1 °C to about 7 °C, about 0.1 °C to about 8 °C, about 0.1 °C to about 9 °C, about 0.1 °C to about 10 °C, about 0.5 °C to about 1 °C, about 0.5 °C to about 2 °C, about 0.5 °C to about 3 °C, about 0.5 °C to about 4 °C, about 0.5 °C to about 5 °C, about 0.5 °C to about 6 °C, about 0.5 °C to about 7 °C, about 0.5 °C to about 8 °C, about 0.5 °C to about 9 °C, about 0.5 °C to about 10 °C, about 1 °C to about 2 °C, about 1 °C to about 3 °C, about 1 °C to about 4 °C, about 1 °C to about 5 °C, about 1 °C to about 6 °C, about 1 °C to about 7 °C, about 1 °C to about 8 °C, about 1 °C to about 9 °C, about 1 °C to about 10 °C, about 2 °C to about 3 °C, about 2 °C to about 4 °C, about 2 °C to about 5 °C, about 2 °C to about 6 °C, about 2 °C to about 7 °C, about 2 °C to about 8 °C, about 2 °C to about 9 °C, about 2 °C to about 10 °C, about 3 °C to about 4 °C, about 3 °C to about 5 °C, about 3 °C to about 6 °C, about 3 °C to about 7 °C, about 3 °C to about 8 °C, about 3 °C to about 9 °C, about 3 °C to about 10 °C, about 4 °C to about 5 °C, about 4 °C to about 6 °C, about 4 °C to about 7 °C, about 4 °C to about 8 °C, about 4 °C to about 9 °C, about 4 °C to about 10 °C, about 5 °C to about 6 °C, about 5 °C to about 7 °C, about 5 °C to about 8 °C, about 5 °C to about 9 °C, about 5 °C to about 10 °C, about 6 °C to about 7 °C, about 6 °C to about 8 °C, about 6 °C to about 9 °C, about 6 °C to about 10 °C, about 7 °C to about 8 °C, about 7 °C to about 9 °C, about 7 °C to about 10 °C, about 8 °C to about 9 °C, about 8 °C to about 10 °C, or about 9 °C to about 10 °C.

In some embodiments, temperature regulation may be provided to a plurality of body parts of the user. For example, the system described herein may provide temperature regulation to a head of a user, a torso of a user, one or more arms of a user, one or more legs of a user, one or more feet of a user, or any combinations thereof. In some embodiments, a portion of the bedding (e.g., blanket) may provide temperature regulation to at least one body part of the user. In some embodiments, the bedding (e.g., blanket) may comprise a first portion and a second portion. The first portion of the bedding (e.g., blanket) may provide a first temperature and a second portion of the bedding (e.g., blanket) may provide a second temperature. In some embodiments, the first portion of the bedding (e.g., blanket) may provide a first temperature to a first body part of a user and the second portion of the bedding (e.g., blanket) may provide a second temperature to a second body part of a user. In some embodiments, the first body part and the second body part may be the same. In some embodiments, the first body part and the second body part may be different.

In some embodiments, the first temperature and the second temperature may be the same or substantially similar. In some embodiments, the first temperature and the second temperature may be different. In some embodiments, the first temperature and the second temperature may be different by a range from about 0.1 °C to about 10 °C. In some embodiments, the first temperature and the second temperature may be different by a range from about 0.1 °C to about 0.5 °C, about 0.1 °C to about 1 °C, about 0.1 °C to about 2 °C, about 0.1 °C to about 3 °C, about 0.1 °C to about 4 °C, about 0.1 °C to about 5 °C, about 0.1 °C to about 6 °C, about 0.1 °C to about 7 °C, about 0.1 °C to about 8 °C, about 0.1 °C to about 9 °C, about 0.1 °C to about 10 °C, about 0.5 °C to about 1 °C, about 0.5 °C to about 2 °C, about 0.5 °C to about 3 °C, about 0.5 °C to about 4 °C, about 0.5 °C to about 5 °C, about 0.5 °C to about 6 °C, about 0.5 °C to about 7 °C, about 0.5 °C to about 8 °C, about 0.5 °C to about 9 °C, about 0.5 °C to about 10 °C, about 1 °C to about 2 °C, about 1 °C to about 3 °C, about 1 °C to about 4 °C, about 1 °C to about 5 °C, about 1 °C to about 6 °C, about 1 °C to about 7 °C, about 1 °C to about 8 °C, about 1 °C to about 9 °C, about 1 °C to about 10 °C, about 2 °C to about 3 °C, about 2 °C to about 4 °C, about 2 °C to about 5 °C, about 2 °C to about 6 °C, about 2 °C to about 7 °C, about 2 °C to about 8 °C, about 2 °C to about 9 °C, about 2 °C to about 10 °C, about 3 °C to about 4 °C, about 3 °C to about 5 °C, about 3 °C to about 6 °C, about 3 °C to about 7 °C, about 3 °C to about 8 °C, about 3 °C to about 9 °C, about 3 °C to about 10 °C, about 4 °C to about 5 °C, about 4 °C to about 6 °C, about 4 °C to about 7 °C, about 4 °C to about 8 °C, about 4 °C to about 9 °C, about 4 °C to about 10 °C, about 5 °C to about 6 °C, about 5 °C to about 7 °C, about 5 °C to about 8 °C, about 5 °C to about 9 °C, about 5 °C to about 10 °C, about 6 °C to about 7 °C, about 6 °C to about 8 °C, about 6 °C to about 9 °C, about 6 °C to about 10 °C, about 7 °C to about 8 °C, about 7 °C to about 9 °C, about 7 °C to about 10 °C, about 8 °C to about 9 °C, about 8 °C to about 10 °C, or about 9 °C to about 10 °C.

In some embodiments, the system can comprise at least one reservoir. The reservoir may be configured to house a volume of fluid. In some embodiments, the system can comprise 1, 2, 3, 4, or more reservoirs. The system may comprise a reservoir with multiple containers (e.g., a reservoir with two containers to hold two distinct volumes of fluid). The fluid may flow from the reservoir to the bedding (e.g., blanket) described herein. In some embodiments, the at least one reservoir may have one or more orifices by which fluid may exit the reservoir. In some embodiments, a reservoir may have 1, 2, 3, 4, 5, or more orifices. In some embodiments, the system comprises one or more fluid flow controllers to modulate a direction of fluid and/or a rate of fluid flow. In some embodiments, the fluid may flow through one or more cords (e.g., umbilical cords) as show in FIGS. 1A-1C. For example, the fluid may flow from a reservoir (e.g., hub) to a bed cover and then to a bedding (e.g., blanket). The fluid may flow to a bed cover via a first cord (e.g., cover umbilical cord) and then from a first cord through a second cord (e.g., blanket umbilical cord) to the bedding (e.g., blanket). This arrangement may provide the same fluid flowing in the bed cover to the bedding (e.g., blanket). In some embodiments, the fluid may flow through one or more cords (e.g., umbilical cords) as show in FIGS. 2A-2C. For example, the fluid may flow from a reservoir (e.g., hub) to a bed cover and a bedding (e.g., blanket). There may be two or more orifices of the reservoir through which volumes of fluid may flow to the bed cover and bedding (e.g., blanket). In some embodiments, the reservoir may have one orifice and a cord with multiple partitions, as shown in FIG. 2A. The fluid may flow from the reservoir and then split at an intersection of the cord. At the intersection, the fluid may flow to the bed cover (e.g., via the cover umbilical) and/or the fluid may flow to the bedding (e.g., blanket) via the blanket umbilical. In some embodiments, a gate (e.g., valve) may be present to section off fluid flow to a bed cover and/or bedding (e.g., blanket). This arrangement may provide different volumes of fluid to flow to the bed cover and bedding (e.g., blanket). In some embodiments, the different volumes of fluid may have the same temperature. In some embodiments, the different volumes of fluid may have similar temperatures. In some embodiments, the different volumes of fluid may have different temperatures.

The system may comprise a closed-loop configuration by which the fluid may not flow back to a reservoir. In some embodiments, the fluid may exit the reservoir and flow through the one or more cords to a bed cover, bedding (e.g., blanket), or combination thereof. In some embodiments, the temperature of the fluid may be regulated by the reservoir. In some embodiments, the temperature of the fluid may not be regulated by the reservoir. In some embodiments, the system may comprise a temperature regulator configured to regulate a temperature of a volume of fluid. In some embodiments, the system may comprise at least about one temperature regulator, at least about two temperature regulators, at least about three temperature regulators, or greater than about three temperature regulators. In some embodiments, the system may comprise at most about three temperature regulators, at most about two temperature regulators, at most about one temperature regulator, or less than about one temperature regulator. In some embodiments, a temperature regulator may be configured to regulate temperature of multiple volumes of fluid. For example, a temperature regulator may be configured to regulate a first temperature of a first fluid flowing to a bed cover described herein and a second temperature of a second fluid flowing to a bedding (e.g., blanket) described herein. In some embodiments, the system may comprise two or more temperature regulators (e.g., 2 temperature regulators) to each regulate a temperature of a volume of fluid. For example, a first temperature regulator may be configured to regulate a first temperature of a first fluid flowing to a bed cover described herein, and a second temperature regulator may be configured to regulate a second temperature of a second fluid flowing to a bedding (e.g., blanket) described herein.

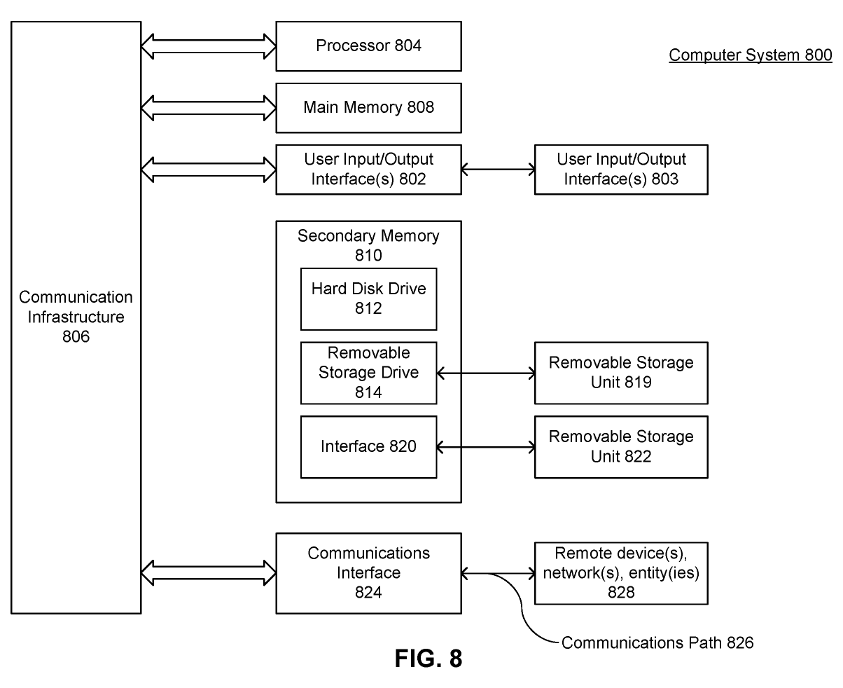

The temperature regulator may be controlled or directed by a computer system, such as described in further detail below with respect to FIG. 8. The computer system may control both the bed cover and the blanket. In an embodiment, the bed cover and the blanket may share the same temperature (i.e., any change to the bed cover may be reflected in the blanket) and the bed cover and blanket may share a single temperature regulator. For example, the computer system may include a controller that determines target temperatures within the bedding based on sensor data, sleep phase, user preferences, and/or historical sleep data, and applies those targets across all connected bedding components. When a temperature of the bed cover is changed (manually or by the automated system), the controller may direct the temperature regulator to apply the same change to the blanket–i.e., synchronize the temperature of the blanket and the bed cover. In an embodiment, a user may input a preferred temperature in a mobile application interface, with processing routed through a cloud infrastructure to the temperature regulator.

In some embodiments, the bedding (e.g., blanket) can comprise a weight. In some embodiments, a weight of the bedding (e.g., blanket) may be at least about 5 pounds (lbs.), at least about 6 lbs., at least about 7 lbs., at least about 8 lbs., at least about 9 lbs., at least about 10 lbs., at least about 11 lbs., at least about 12 lbs., at least about 13 lbs., at least about 14 lbs., at least about 15 lbs., at least about 20 lbs., at least about 25 lbs., or greater than about 25 lbs. In some embodiments, a weight of the bedding (e.g., blanket) may be at most about 25 lbs., at most about 20 lbs., at most about 15 lbs., at most about 14 lbs., at most about 13 lbs., at most about 12 lbs., at most about 11 lbs., at most about 10 lbs., at most about 9 lbs., at most about 8 lbs., at most about 7 lbs., at most about 6 lbs., at most about 5 lbs., or less than about 5 lbs. In some embodiments, a weight of the bedding (e.g., blanket) may be from about 5 lbs. to about 20 lbs. In some embodiments, a weight of the bedding (e.g., blanket) may be from about 5 lbs. to about 6 lbs., about 5 lbs. to about 7 lbs., about 5 lbs. to about 8 lbs., about 5 lbs. to about 9 lbs., about 5 lbs. to about 10 lbs., about 5 lbs. to about 11 lbs., about 5 lbs. to about 12 lbs., about 5 lbs. to about 13 lbs., about 5 lbs. to about 14 lbs., about 5 lbs. to about 15 lbs., about 5 lbs. to about 20 lbs., about 6 lbs. to about 7 lbs., about 6 lbs. to about 8 lbs., about 6 lbs. to about 9 lbs., about 6 lbs. to about 10 lbs., about 6 lbs. to about 11 lbs., about 6 lbs. to about 12 lbs., about 6 lbs. to about 13 lbs., about 6 lbs. to about 14 lbs., about 6 lbs. to about 15 lbs., about 6 lbs. to about 20 lbs., about 7 lbs. to about 8 lbs., about 7 lbs. to about 9 lbs., about 7 lbs. to about 10 lbs., about 7 lbs. to about 11 lbs., about 7 lbs. to about 12 lbs., about 7 lbs. to about 13 lbs., about 7 lbs. to about 14 lbs., about 7 lbs. to about 15 lbs., about 7 lbs. to about 20 lbs., about 8 lbs. to about 9 lbs., about 8 lbs. to about 10 lbs., about 8 lbs. to about 11 lbs., about 8 lbs. to about 12 lbs., about 8 lbs. to about 13 lbs., about 8 lbs. to about 14 lbs., about 8 lbs. to about 15 lbs., about 8 lbs. to about 20 lbs., about 9 lbs. to about 10 lbs., about 9 lbs. to about 11 lbs., about 9 lbs. to about 12 lbs., about 9 lbs. to about 13 lbs., about 9 lbs. to about 14 lbs., about 9 lbs. to about 15 lbs., about 9 lbs. to about 20 lbs., about 10 lbs. to about 11 lbs., about 10 lbs. to about 12 lbs., about 10 lbs. to about 13 lbs., about 10 lbs. to about 14 lbs., about 10 lbs. to about 15 lbs., about 10 lbs. to about 20 lbs., about 11 lbs. to about 12 lbs., about 11 lbs. to about 13 lbs., about 11 lbs. to about 14 lbs., about 11 lbs. to about 15 lbs., about 11 lbs. to about 20 lbs., about 12 lbs. to about 13 lbs., about 12 lbs. to about 14 lbs., about 12 lbs. to about 15 lbs., about 12 lbs. to about 20 lbs., about 13 lbs. to about 14 lbs., about 13 lbs. to about 15 lbs., about 13 lbs. to about 20 lbs., about 14 lbs. to about 15 lbs., about 14 lbs. to about 20 lbs., or about 15 lbs. to about 20 lbs.

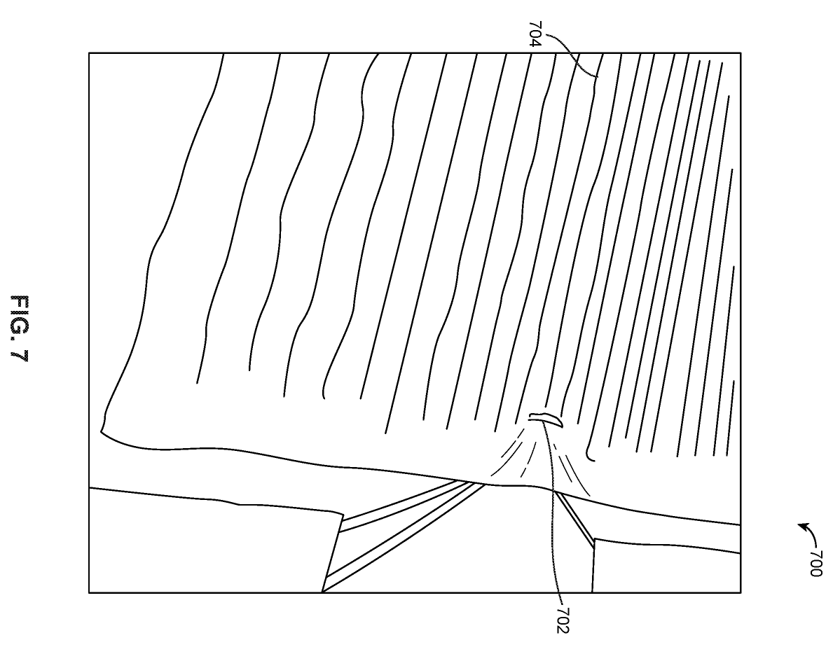

FIG. 6 is an example representation of fluid channels 600 that may be implemented within the bedding described herein. Fluid channels 600 may be fluidically connected to the manifold component(s). Fluid channels 600 may comprise individual tubes or conduits through which temperature-regulated fluid can flow to provide thermal regulation to specific portions of the blanket. Fluid channels 600 may be arranged in various orientations, arrangements, patterns, and densities depending on the thermal requirements of different blanket zones.

In some embodiments, the system can comprise a primary manifold 610 that may be configured to receive and distribute fluid flow throughout the system. Primary manifold 610 may serve as a central distribution point for temperature-regulated fluid entering the blanket system.

In some embodiments, the system may further comprise one or more secondary manifold components, for example, a first secondary manifold 620A, a second secondary manifold 620B, a third secondary manifold 620C, and/or a fourth secondary manifold 620D. Each secondary manifold may be configured to receive fluid from primary manifold 610 and further distribute the fluid to specific zones or regions of the blanket. The secondary manifold components may be positioned strategically throughout the blanket to ensure optimal fluid distribution and temperature regulation across different areas of the bedding.

The manifold configuration shown in FIG. 6 may represent either a flexible manifold design or a distributed manifold design, according to some embodiments. A flexible manifold may allow for greater adaptability and movement within the blanket structure, while a distributed manifold may provide more precise control over fluid distribution to specific zones. The manifold system may be designed to minimize overlapping of tubes and may help ensure balanced flow rates across all connected fluid channels 600.

In some embodiments, the manifold components may be constructed from materials that are compatible with the temperature-regulated fluid and may be designed to withstand repeated thermal cycling. The manifold system may be integrated within the blanket structure in a manner that maintains comfort while providing effective thermal regulation. The positioning and configuration of primary manifold 610 and the various secondary manifold components may be optimized to provide uniform temperature distribution while minimizing the overall weight and bulk of the blanket system.

FIG. 7 shows a representation of elongate support members 704 for the bedding described herein. Blanket 700 can include a plurality of fluid channels and associated components for temperature regulation. In some embodiments, blanket 700 may comprise manifold 702 which can be configured to distribute fluid flow throughout the system. Manifold 702 may be positioned to facilitate efficient fluid distribution across multiple zones or regions of blanket 700.

In some embodiments, the system may include one or more support member 704 that can be disposed between fluid channels within blanket 700. Support member 704 components may be configured as elongate structures that can provide structural support and comfort enhancement to the bedding system. Support member 704 elements may comprise, for example, textile materials such as ropes, cords, tubes, strings, foam, threads, ribbons, or any combination thereof. In some embodiments, the support member 704 components may be laid in between the tube arrangement to provide improved uniformity and comfort characteristics.

Support member 704 elements may be positioned strategically throughout blanket 700 to enhance the overall feel and performance of the bedding system. In some embodiments, these support member 704 components may have cross-sectional dimensions that are similar to or different from the fluid channels by predetermined percentages. Support member 704 elements may serve to provide structural integrity and comfort optimization.

### Methods for Optimizing Sleep

In an aspect, provided herein is a method for optimizing sleep of a user. In some embodiments, the method comprises optimizing sleep of a user with a system described herein. The method can comprise contacting at least one body part of the user with a bedding (e.g., a blanket). In some embodiments, the method can comprise directing a flow of fluid (e.g., temperature-regulated fluid). The fluid (e.g., temperature-regulated fluid) may be directed through a manifold described herein. In some embodiments, the fluid (e.g., temperature-regulated fluid) may be directed into the plurality of channels housed in the bedding (e.g., a blanket). In some embodiments, regulating a temperature of the fluid (e.g., temperature-regulated fluid) may be performed outside the bedding (e.g., a blanket).

As an example, a method for optimizing sleep of the user with the system provided herein can comprise: (a) contacting the at least one body part of the user with the blanket; and (b) directing flow of the temperature-regulated fluid through the manifold and into the plurality of fluid channels housed within the blanket, optionally wherein regulation of the temperature of the temperature-regulated fluid is performed outside of the blanket.

### Computer Systems

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 802, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

### Example

### Example 1. Exemplary aspects of a blanket

### Connection Options

The bedding has connections. One connection is the hub to the mattress cover to the blanket. A second connection option is the hub to the blanket. A third connection option is the hub to the base to the blanket and mattress cover. Connection options are shown in FIGS. 1A-1C and 2A-2C. An adapter is offered that allows old users to use the blanket. FIG. 3 shows the opening of the blanket in which fluid may enter.

### Sensing

Hall effect sensing will determine if the blanket is connected properly. A magnet will be in the blanket connector. A hall effect sensor in mating connector (on Pod Cover). The north or south orientation of the magnet is used to detect left or right orientation. A temperature sensor on the water exit from the blanket will be used to measure temperature drop (inlet water temp to blanket measured from the hub).

### Kink resistance

An X-spline will be in tubes. There will be plurality of channels (e.g., plurality of tubes) so if one tube kinks, it only knocks out one zone vs. whole blanket. Horizontal tubes will be used to make it so that if a user folds the top of the blanket, then the user will only kink or block the top section and not the entire blanket. The blanket will have angled runs at the bottom corners because this is where blankets fold weird around the mattress. The angled runs will help minimize kinks.

### Comfort

There will be horizontal tubes at the top of the blanket to make it feel more comfortable against the chin. Vertical bends feel harder than horizontal tubes. Elongate support members or materials will be placed in between tubes to even out the feel of the blanket. These elongate support members are rope, foam, 3D spacer mesh, dummy tubes, or combinations thereof. FIG. 7 shows an example of elongate support members placed in between tubes of the blanket. There will not be tubes at the foot area. The target arrangement may have tubes at the knees for the top 5% of height for people and above the feet for the bottom 5% of height for people. The blanket may be flipped in order to provide users with a “comfort side” and a “performance side.” The blanket will have replaceable bottom layers with different levels of insulation that allow users to adjust thermal performance vs. comfort. The blanket has material removed from a layer to reduce weight. An exemplary arrangement of channels or plurality of channels is shown in FIG. 5. The arrangement has eight channels and zones of the blanket, with a first zone 510, second zone 520, third zone 530, fourth zone 540, fifth zone 550, sixth zone 560, seventh zone 570, and eighth zone 580.

### Thermal performance

The blanket will have adjusted tube spacing and size (e.g., diameter) to give adequate thermal transfer while minimizing weight of tubes and water in the blanket. The blanket will have adjusted tube zones to balance tube lengths so that flow rate and temperature is even between all zones. The blanket will be designed so that tube runs in the blanket so that the flow is balanced with another bed device (e.g., mattress cover). This arrangement provides for about 60-70% flow through the mattress cover and about 30-40% flow through blanket.

### Connector

Hall effect sensing will determine if the blanket is connected properly. A magnet will be in the blanket connector. A hall effect sensor will be present in mating connector (on Pod Cover). The north or south orientation of the magnet is used to detect left or right orientation. A temperature sensor on the water exit from the blanket will be used to measure temperature drop (inlet water temp to blanket measured from the hub).

### Manifolds

Tube manifolds will be present to help avoid overlapping of tubes. The manifold will be a distributed manifold or a flexible manifold. An exemplary manifold is shown in FIG. 6.

### Test thermal performance of the system with tubes

Different tube spacing are tested, for example 20 mm vs. 40 mm vs. 75 mm. Different tube sizes are tested, for example 7.5 mm outer diameter vs. 6.0 mm.

### Different layer constructions

Different fabrics are tested to assess comfort and thermal performance. For example, cotton vs. polyester vs. viscose vs. blends are tested. Synthetics tend to conduct heat much better and improves thermal performance vs. cotton. FIG. 4 shows a view of the multiple layer construction of the blanket. Different air flow permeability of fabrics is tested. The low permeability materials trap heat and moisture.

### Weight

Different weighted materials are tested. Thin materials are found to reduce weight, however these thin materials feel cheap. The objective is to find the maximum weight that users can tolerate, which seems to be around 15-16 lbs with water.

### Comfort / tube feel

Insulation is tested under the tubes of the blanket, however this is found to reduce or eliminate thermal performance. Foam is tested between channels (e.g., tubes) (in the empty space between tubes). Different diameters of foam are tested. If the foam is too thick, it is hypothesized that it will lead to tubes not touching the body. Tubes of different firmness are tested to assess comfort level. Elongate support members (e.g., ropes) are placed between tubes. The ropes are of similar diameter to the tubes.

### Flow balancing

Different tube patterns are tested to ensure that flow is balanced across all sections. Flow is tested through the blanket and other connected bed devices (e.g., mattress cover).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein can be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system for regulating bedding temperature, comprising:
a blanket;
a plurality of fluid channels disposed within the blanket; and
a temperature regulator fluidically coupled to the plurality of fluid channels, the temperature regulator configured to circulate a fluid through the plurality of fluid channels to regulate a temperature of the blanket.

2. The system of claim 1, further comprising:
a manifold disposed within the blanket, the manifold configured to divide a flow of the fluid into the plurality of fluid channels.

3. The system of claim 2, wherein the blanket comprises a first thermal zone disposed in a first area of the blanket and a second thermal zone disposed in a second area of the blanket.

4. The system of claim 3, wherein the manifold is a first manifold configured to divide a first flow of the fluid into a first plurality of fluid channels in the first thermal zone, and wherein the system further comprises a second manifold disposed within the blanket, the second manifold configured to divide a second flow of the fluid into a second plurality of fluid channels in the second thermal zone.

5. The system of claim 1, further comprising:
a memory; and
at least one processor coupled to the memory and configured to:
obtain a current temperature and a target temperature of at least a portion of the blanket; and
direct the temperature regulator to change the current temperature based on the target temperature.

6. The system of claim 1, wherein a first portion of the blanket has a lower density of the plurality of fluid channels compared to a second portion of the blanket.

7. The system of claim 1, further comprising:
at least one elongate support member disposed between two fluid channels of the plurality of fluid channels.

8. The system of claim 7, wherein a cross-sectional dimension of the elongate support member and a cross-sectional dimension of a fluid channel adjacent to the elongate support member are substantially the same.

9. The system of claim 1, wherein a first portion of the blanket is configured to provide a first temperature to a first body part of a user and a second portion of the blanket is configured to provide a second temperature to a second body part of a user.

10. The system of claim 1, wherein the blanket comprises a first fabric layer disposed above the plurality of fluid channels and a second fabric layer disposed below the plurality of fluid channels, wherein at least a portion of the first fabric layer and at least a portion of the second fabric layer are coupled to one another to enclose the plurality of fluid channels between the first fabric layer and the second fabric layer.

11. The system of claim 1, wherein the plurality of fluid channels comprises at least one horizontally-oriented fluid channel disposed at a top region of the blanket.

12. The system of claim 1, wherein at least one fluid channel of the plurality of fluid channels comprises an internal X-spline configured to provide kink resistance.

13. The system of claim 1, further comprising:
a bed cover; and
a second plurality of fluid channels disposed within the bed cover,
wherein the temperature regulator is fluidically coupled to the second plurality of fluid channels and is configured to circulate the fluid through the second plurality of fluid channels to regulate a temperature of the bed cover.

14. The system of claim 13, wherein the blanket and the bed cover are regulated to a same temperature.

15. The system of claim 13, wherein the blanket and the bed cover are regulated to different temperatures.

16. The system of claim 13, further comprising:
a memory; and
at least one processor coupled to the memory and configured to:
synchronize a current temperature of the bed cover and the blanket.

17. The system of claim 13, further comprising a first umbilical fluidically connecting the temperature regulator to the bed cover and a second umbilical fluidically connecting the temperature regulator to the blanket.

18. The system of claim 13, further comprising a first umbilical fluidically connecting the temperature regulator to the bed cover and a second umbilical fluidically connecting the bed cover to the blanket.

19. The system of claim 1, further comprising a magnetic field sensor that detects a left or right orientation of the blanket based on a polarity of a magnet.

20. The system of claim 1, further comprising a temperature drop sensor on a fluid exit channel from the blanket used to determine a temperature drop within the blanket.

21. The system of claim 1, wherein the blanket comprises a bottom side and a top side opposite the bottom side, wherein the bottom side and the top side exhibit different heat transfer coefficient values.

22. A method for regulating bedding temperature, comprising:
receiving, by one or more processors, data indicating a current temperature of a blanket;
determining, by the one or more processors, a target temperature for the blanket that differs from the current temperature; and
directing, by the one or more processors, a temperature regulator fluidically coupled to the blanket to change the current temperature of the blanket to the target temperature by circulating a fluid through a plurality of fluid channels, the plurality of fluid channels at least partially disposed within the blanket.

23. A non-transitory computer-readable device having instructions stored thereon that, when executed by at least one computing device, causes the at least one computing device to perform operations for regulating bedding temperature, comprising:
receiving data indicating a current temperature of a blanket;
determining a target temperature for the blanket that differs from the current temperature; and
directing a temperature regulator fluidically coupled to the blanket to change the current temperature of the blanket to the target temperature by circulating a fluid through a plurality of fluid channels, the plurality of fluid channels at least partially disposed within the blanket.
